(19) United States
(12) Patent Application Publication
(10) Pub. No.: US 2004/0147034 A1
(43) Pub. Date: Jul. 29, 2004

(54) Method and apparatus for measuring a substance in a biological sample

(76) Inventors: Jay Prabhakar Gore, West Lafayette, IN (US); Sivakumar Santhanakrishnan, Indianapolis, IN (US); Kislaya Kunjan, West Lafayette, IN (US); Anjan Mehta, Acton, MA (US); Paul J. Mulqueen, Greenfield, IN (US)

Correspondence Address: BARNES & THORNBURG, 11 SOUTH MERIDIAN, INDIANAPOLIS, IN, 46204

(21) Appl. No.: 10/692,996

(22) Filed: Oct. 24, 2003

Related U.S. Application Data
(63) Continuation-in-part of application No. PCT/US02/22899, filed on Jul. 18, 2002.
(60) Provisional application No. 60/312,165, filed on Aug. 14, 2001.

(51) Int. Cl. G01N 21/59

(52) U.S. Cl. 436/95; 250/339.12; 600/316; 436/164; 436/171; 356/39; 356/432; 356/436; 250/340; 250/341.8

(57) ABSTRACT

Method and apparatus for measuring the amount of an organic substance in a biological sample using infrared electromagnetic radiation. For example, glucose levels can be detected in capillary fluid filtrate obtained subcutaneously in a continuous manner in order to provide real-time glucose monitoring for a patient with diabetes.

### CROSS REFREENCE TO RELATED APPLICATIONS

This application is a continuation in part of and claims priority to International Application Number PCT/US02/22899 entitled “Measuring a Substance in a Biological Sample” having an international filing date of Jul. 18, 2002, which claims priority to U.S. Provisional Application No. 60/312,165 filed Aug. 14, 2001, both of which are incorporated herein by reference in their entirety.

### TECHNICAL FIELD OF THE INVENTION

The present invention generally relates to methods of measuring the amount of an organic substance in a sample and is particularly related to methods of measuring the amount of an organic substance, such as glucose, in a biological sample using infrared radiation.

### BACKGROUND OF THE INVENTION

An estimated 16 million Americans (approximately 7% of the total population in the United States) have diabetes, a disease which can cause severe damage to the heart, kidneys, eyes, and nerves. Diabetics need to monitor their blood glucose levels frequently, often as much as six times a day, to maintain a proper level of insulin in their blood. Intense testing and treatment of diabetes can reduce the complications, including blindness, kidney failure and heart attack, by as much as 70%.

Methods of measuring glucose are broadly divided into two categories: i.e., those based on chemical methods and those based on optical methods. Chemical methods of measuring blood glucose (e.g., an enzyme-based method) typically require the physical contact of a biological fluid with a sensing element utilized in the chemical method. One example of an apparatus which uses a chemical method is a blood glucose meter designed to measure the level of glucose in a sample of a patient's blood. In particular, a small amount of a suitable reagent is printed or otherwise deposited onto an elongated plastic strip which can be inserted into the blood glucose meter after contacting a blood sample from the patient. The meter includes a reflectometry based measuring system which detects a change in the color of the printed reagent due to a reaction between the active reagent and glucose present in the blood sample.

It should be appreciated that the accuracy of the meter is important where a patient determines an insulin treatment regime based upon blood glucose measurements obtained from a blood glucose meter. This requires very precise calibration of the meter. Initial calibration of the meter is normally carried out during and immediately following manufacturing, with certain calibration data being stored in permanent memory of the meter. However, calibration of the meter at this stage cannot easily account for changes and variations in the properties of the consumable reagents themselves, variations which might arise due to slight changes in the manufacturing process of the reagent and the test strip, environmental factors such a temperature and humidity, and changes in the property of the reagent over time.

Accordingly, measuring glucose levels with chemical methods may lead to inaccuracies.

Additional drawbacks to chemical methods include the manner in which they typically obtain the biological fluid. In particular, obtaining a blood sample typically involves pricking a finger of the diabetic patient. The aforementioned pricking is invasive, painful, and has a risk of infection. The self-pricking also requires a conscious and mindful patient. As such, chemical methods which involve pricking are inconvenient, and they often prevent the diabetic patient from performing the needed frequent testing. Moreover, because chemical methods typically include components which require periodic replacement, utilizing these methods can be costly.

With respect to optical methods, they typically rely upon absorption, scattering, and fluorescence to determine the content of glucose in a biological sample. These methods do not require physical contact with the sensing element, have relatively fast response times, and may require fewer calibration measurements.

However, these methods suffer from the draw back that the equipment utilized to gather the optical data tends to be large, complex, and cumbersome and thus does not lend itself to being portable and easily used by a patient.

Therefore, in light of the above discussion, it is apparent that there are needs for a method of measuring an amount of an organic substance in a biological sample that addresses one or more of the above-discussed drawbacks, as well as an apparatus useful for carrying out the method.

### SUMMARY OF THE INVENTION

In one illustrative embodiment, a method for determining a patient glucose level is provided. The method includes obtaining a sample of a cell-free, blood-based body fluid in a sample container having a pre-defined measurement path, passing an incident infrared signal through the sample over the measurement path. The incident signal is modulated and includes wavelengths in a measurement range of from 3 to 11 microns and at least two glucose absorbance bands in the measurement range and at least one reference band. The method also involves detecting a post-absorbance signal including all three of the bands after the incident signal is absorbed by the sample using a detector configured to preferentially detect said modulated signal relative to unmodulated signals, and calculating glucose concentration in the sample from the post-absorbance signal.

In yet another illustrative embodiment, there is provided a method for determining a patient glucose level. The method for determining a patient glucose level includes obtaining a sample of a biological fluid in a sample cell having a path of defined pathlength for infrared absorption and transmitting mid infrared radiation through the sample along the path. The incident signal is modulated and includes at least two glucose absorbance bands and at least one reference band. The method also includes detecting radiation from the two glucose absorbance bands and the reference band after the radiation is absorbed by the sample using a detector configured to detect the modulated radiation. The method also includes generating an electrical signal in response to detecting the modulated radiation and receiving the electrical signal with a signal processor configured to process the electrical signal with a quantification algorithm; and processing the electrical signal with the quantification algorithm, thereby providing a measurement of glucose contained within the biological sample.

In yet another illustrative embodiment there is provided an apparatus for measuring a patient glucose level. The apparatus includes the following operably connected elements: an ultrafiltration membrane that allows passage of capillary filtrate fluid is adapted to be placed at a subcutaneous location in a patient body; a catheter operably connected to the membrane to transport a capillary filtrate fluid from the subcutaneous location to a location outside said patient body; a vacuum operably connected to the catheter and providing motive force to fluid in the catheter; a sample cell operably connected to the catheter for receiving capillary filtrate from the subcutaneous location and the sample cell having a defined path for passage of infrared radiation through a sample of capillary fluid filtrate; a modulated mid-infrared radiation source including at least two glucose absorbance bands and at least one reference band and adapted to transmit over the defined path; a detector for detecting radiation from the two glucose absorbance bands and the reference band after the radiation is absorbed by the sample and then generating an electrical signal in response to detecting the modulated radiation; and a signal processor configured to process the electrical signal with a quantification algorithm, thereby providing a measurement of glucose contained within the capillary filtrate fluid.

In yet another exemplary embodiment there is provided an apparatus for detecting information to be used in determining a patient glucose level in a fluid. The apparatus includes: a measurement container for receiving fluid at a measurement location and adapted to allow an infrared signal to pass through the fluid over a measurement path of predetermined length; a signal generator adapted to transmit over the measurement path a modulated incident signal that includes wavelengths in a measurement range of from 3 to 11 microns including within the measurement range at least two glucose absorbance bands and at least one reference band; and a detector configured to preferentially detect said modulated signal relative to unmodulated signals and located to detect a post-absorbance signal comprising all three of the above bands after the incident signal is absorbed by the sample.

In another illustrative embodiment, there is provided a method of measuring an amount of an organic substance contained within a biological sample. The organic substance has an infrared absorption spectrum which includes a set (n) of wavelength regions, wherein each of the wavelength regions substantially corresponds to an absorption band of the absorption spectrum. The method includes (a) detecting the intensity of a number of selected wavelength bands of infrared electromagnetic radiation influenced by the organic substance contained within the biological sample with a detection system, wherein (i) each of the selected wavelength bands substantially corresponds to one of the wavelength regions, and (ii) the number of the selected wavelength bands is equal to n−1 or less, (b) generating an electrical signal in response to detecting the intensity of the number of the selected wavelength bands, (c) receiving the electrical signal with a signal processor configured to process the electrical signal with a quantification algorithm, and (d) processing the electrical signal with the quantification algorithm so as to provide a measurement of the amount of the organic substance contained within the biological sample.

In another illustrative embodiment a method of measuring an amount of glucose in a biological fluid is provided. The glucose has an infrared absorption spectrum which includes a set (n) of infrared wavelength regions, wherein each of the infrared wavelength regions substantially corresponds to an infrared absorption band of the infrared absorption spectrum. The method includes (a) detecting the transmittance of a number of selected wavelength bands of infrared electromagnetic radiation absorbed by the glucose contained within the biological fluid with a detection system, wherein (i) each of the selected wavelength bands substantially corresponds to one of the wavelength regions, and (ii) the number of the selected wavelength bands is equal to n−1 or less, (b) generating an electrical signal in response to detecting the transmittance of the infrared electromagnetic radiation, (c) receiving the electrical signal with a signal processor configured to process the electrical signal with a quantification algorithm, and (d) processing the electrical signal with the quantification algorithm so as to provide a measurement of the amount of the glucose contained within the biological fluid.

In yet another illustrative embodiment a method of measuring a concentration of an organic substance contained within a biological fluid is provided. The organic substance has an infrared absorption spectrum which includes a set (n) of infrared wavelength regions, wherein each of the infrared wavelength regions substantially corresponds to an infrared absorption band of the infrared absorption spectrum. The method includes (a) detecting the transmittance of a number of selected wavelength bands of infrared electromagnetic radiation absorbed by the organic substance contained within the biological fluid with a detection system, wherein (i) each of the selected wavelength bands substantially corresponds to one of the wavelength regions, and (ii) the number of the selected wavelength bands is equal to n−1 or less, (b) generating an electrical signal in response to detecting the transmittance of the selected infrared electromagnetic radiation wavelength bands, (c) receiving the electrical signal with a signal processor configured to process the electrical signal with a mathematical model, and (d) processing the electrical signal with the mathematical model so as to provide a measurement of the concentration of the organic substance contained within the biological fluid.

In yet another illustrative embodiment there is provided a method of measuring an amount of an organic substance contained within a biological sample. The organic substance has an infrared absorption spectrum which includes a set (n) of wavelength regions, wherein each of the wavelength regions substantially corresponds to an absorption band of the absorption spectrum. The method includes (a) illuminating the biological sample with infrared electromagnetic radiation, wherein the infrared electromagnetic radiation includes (i) one or more wavelength bands of the infrared electromagnetic radiation which are absorbed by the organic substance contained within the biological sample, and (ii) one or more reference wavelength bands which are not substantially absorbed by the organic substance contained within the biological sample, (b) selecting a number the wavelength bands of the infrared electromagnetic radiation, wherein (i) each of the selected wavelength bands substantially corresponds to one of the wavelength regions and (ii) the number of the selected wavelength bands is a subset of (n), (c) selecting a number of reference wavelength bands, (d) detecting the intensity of only (i) the subset of the selected wavelength bands absorbed by the organic substance contained within the biological sample with a detection system, and (ii) the number of reference wavelength bands, (e) generating one or more electrical signals in response to detecting the intensity of only (i) the subset of the selected wavelength bands (ii) the number of reference wavelength bands, (f) receiving the one or more electrical signals with a signal processor configured to process the electrical signals with a quantification algorithm, and (g) processing the one or more electrical signals with the quantification algorithm so as to provide a measurement of the amount of the organic substance contained within the biological sample.

In still another illustrative embodiment a method of measuring an amount of an organic substance contained within a biological sample is provided. The organic substance has an infrared absorption spectrum which includes a set (n) of wavelength regions, wherein each of the wavelength regions substantially corresponds to an absorption band of the absorption spectrum. The method includes (a) illuminating the biological sample with infrared electromagnetic radiation, (b) detecting the intensity of the infrared electromagnetic radiation that is absorbed by the organic substance contained within the biological sample, wherein (i) the intensity detection is restricted to a number of selected wavelength bands of infrared electromagnetic radiation, (ii) each of the selected wavelength bands substantially corresponds to one of the wavelength regions, and (iii) the number of the selected wavelength bands is a subset of (n), (c) generating an electrical signal in response to detecting the intensity of the subset of the selected wavelength bands, (d) receiving the electrical signal with a signal processor configured to process the electrical signal with a quantification algorithm, and (e) processing the electrical signal with the quantification algorithm so as to provide a measurement of the amount of the organic substance contained within the biological sample.

In still another illustrative embodiment a method of measuring an amount of an organic substance contained within a sample is provided. The organic substance has an infrared absorption spectrum which includes a set (n) of wavelength regions, wherein each of the wavelength regions substantially corresponds to an absorption band of the absorption spectrum. The method includes (a) illuminating the sample with infrared electromagnetic radiation, wherein the infrared electromagnetic radiation includes (i) one or more wavelength bands of the infrared electromagnetic radiation which are absorbed by the organic substance contained within the sample (ii) one or more reference wavelength bands which are substantially not absorbed by the organic substance contained within the sample, (b) selecting a number the wavelength bands of the infrared electromagnetic radiation, wherein (i) each of the selected wavelength bands substantially corresponds to one of the wavelength regions and (ii) the number of the selected wavelength bands is a subset of (n), (c) selecting a number of reference wavelength bands, and (d) detecting with a detection system the intensity of only (i) the subset of the selected wavelength bands absorbed by the organic substance contained within the sample and (ii) the number of reference wavelength bands.

In yet another illustrative embodiment a method of measuring an amount of an organic substance contained within a biological sample is provided. The organic substance has an infrared absorption spectrum which includes a set (n) of wavelength regions, wherein each of the wavelength regions substantially corresponds to an absorption band of the absorption spectrum. The method includes (a) illuminating the biological sample with infrared electromagnetic radiation, wherein the infrared electromagnetic radiation includes (i) one or more wavelength bands of the infrared electromagnetic radiation which are absorbed by the organic substance contained within the biological sample and (ii) one or more reference wavelength bands which are substantially not absorbed by the organic substance contained within the biological sample, (b) selecting a number the wavelength bands of the infrared electromagnetic radiation, wherein (i) each of the selected wavelength bands substantially corresponds to one of the wavelength regions and (ii) the number of the selected wavelength bands is a subset of (n), (c) selecting a number of reference wavelength bands, (d) detecting with a detection system the intensity of the infrared electromagnetic radiation, and (e) processing with a mathematical model spectral data only from (i) the subset of the selected wavelength bands absorbed by the organic substance contained within the biological sample and (ii) the number of reference wavelength bands.

These illustrative embodiments are not limiting of the present invention, which is limited only by the appended claims.

### BRIEF DESCRIPTION OF THE DRAWINGS

FIG. 1 shows Attenuated Total Reflectance (ATR) spectra of distilled water, LRS, glucose dissolved in distilled water, and glucose dissolved in LRS;

FIG. 1A shows spectra of glucose and an amino acid;

FIG. 1B shows spectra of glucose, microfiltrated human plasma and ultrafiltrated human plasma;

FIG. 1C shows spectra of glucose and LRS;

FIG. 1D shows spectra of glucose and potassium phosphate.

FIG. 2 is a schematic representation of a sensor;

FIG. 3 is another schematic representation of a sensor;

FIG. 4 is still another schematic representation of a sensor;

FIG. 5A is yet another schematic representation of a sensor;

FIG. 5B is still another schematic representation of a sensor;

FIG. 5C is yet another schematic representation of a sensor;

FIG. 5D is yet another schematic representation of a measuring system according to an embodiment of the present invention;

FIG. 5E is an exploded view of a fluid cell assembly;

FIG. 5F is a fluid flow schematic;

FIG. 6A is a graph showing calibration results;

FIG. 6B is a graph showing cross validation results;

FIG. 7A is a graph showing calibration results;

FIG. 7B is a graph showing cross validation results;

FIG. 8A is a graph showing pure quadratic calibration results;

FIG. 8B is a graph showing pure quadratic delete-1-calibration results;

FIG. 9A is a graph showing pure quadratic calibration results;

FIG. 9B is a graph showing pure quadratic delete-1-calibration results;

FIG. 10 shows baseline corrected ATR spectra of aqueous glucose solutions;

FIG. 11A is a graph showing multiple linear regression calibration, linear fit, results;

FIG. 11B is a graph showing multiple linear regression calibration, quadratic fit, results;

FIG. 12A is a graph showing multiple linear regression calibration, linear fit, results;

FIG. 12B is a graph showing multiple linear regression calibration, quadratic fit, results;

FIG. 13A is a graph showing multivariate calibration results;

FIG. 13B is a graph showing multivariate cross validation results;

FIG. 14 shows baseline corrected ATR spectra of distilled water, LRS, and LRS with 5 different concentrations of added glucose solutions;

FIG. 15A is a graph showing multiple linear regression calibration, linear fit, results;

FIG. 15B is a graph showing multiple linear regression calibration, quadratic fit, results;

FIG. 16A is a graph showing multiple linear regression calibration, linear fit, results;

FIG. 16B is a graph showing multiple linear regression calibration, quadratic fit, results;

FIG. 17A is a graph showing multivariate calibration results;

FIG. 17B is a graph showing cross validation results;

FIG. 18 shows baseline corrected ATR spectra of a number of capillary filtrate collector (CFC) fluid samples collected from pre and post diabetic rats;

FIG. 19A is a graph showing multiple linear regression calibration in CFC fluid, linear fit, results;

FIG. 19B is a graph showing multiple linear regression calibration in CFC fluid, quadratic fit, results;

FIG. 20A is a graph showing multiple linear regression calibration in CFC fluid, linear fit, results;

FIG. 20B is a graph showing multiple linear regression calibration in CFC fluid, quadratic fit, results;

FIG. 21A is a graph showing multivariate calibration results;

FIG. 21B is a graph showing multivariate cross-validation results;

FIG. 22 shows baseline corrected ATR spectra of distilled water and human serum samples with known but varied quantities of glucose added thereto;

FIG. 23A is a graph showing multiple linear regression calibration in human serum, linear fit, results; and

FIG. 23B is a graph showing multiple linear regression calibration in human serum, quadratic fit, results.

### DETAILED DESCRIPTION OF PREFERRED EMBODIMENTS

While the invention is susceptible to various modifications and alternative forms, a specific embodiment thereof has been shown by way of example in the drawings and will herein be described in detail. It should be understood, however, that there is no intent to limit the invention to the particular form disclosed. To the contrary, the intention is to cover all modifications, equivalents, and alternatives falling within the spirit and scope of the invention as defined by the appended claims.

Organic substances can influence electromagnetic radiation. For example, when electromagnetic radiation encounters an organic substance the radiation can be absorbed or transmitted, depending upon the nature of the organic molecules it encounters. If the electromagnetic radiation is absorbed, then the absorption gives rise to absorption bands at particular wavelength regions of an absorption spectrum of the organic substance. (Note that examples of ways to express wavelength regions include, but are not limited to, frequency, wavelength, or wavenumber.)

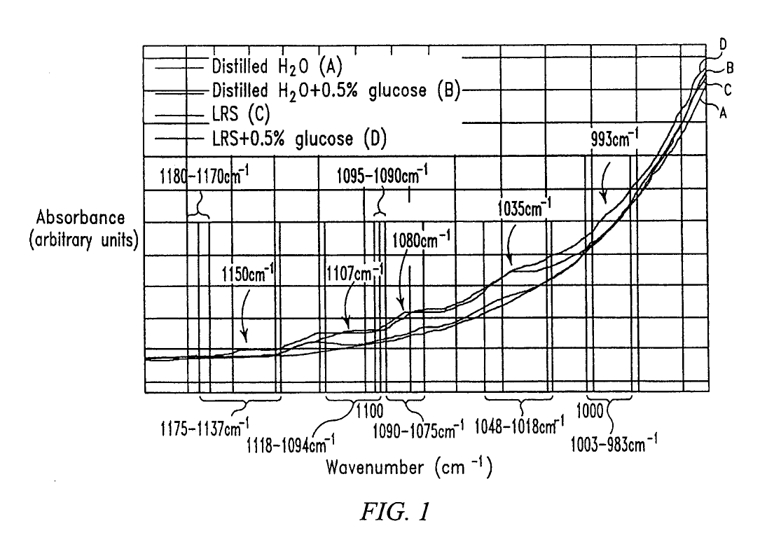

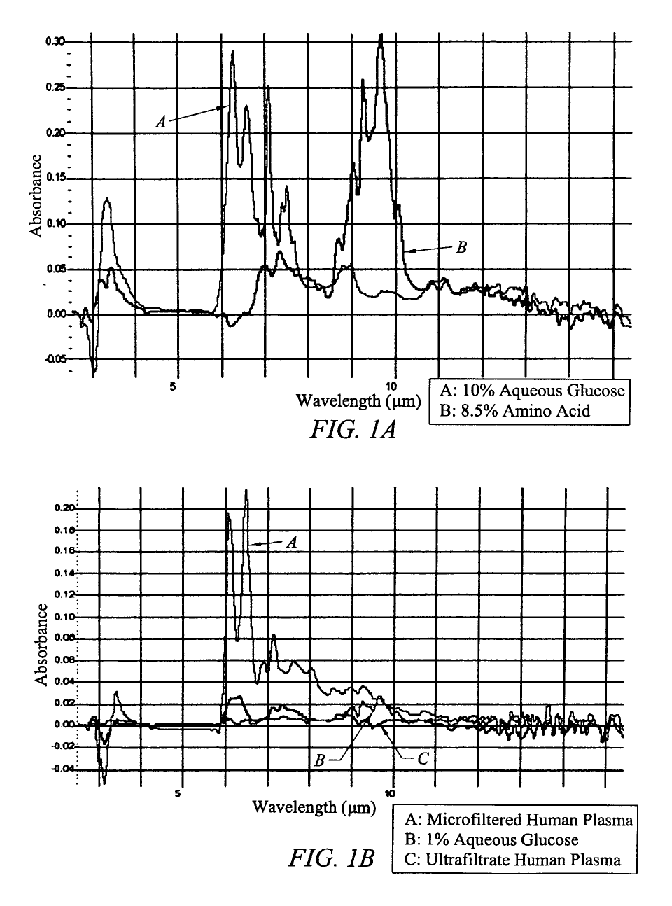

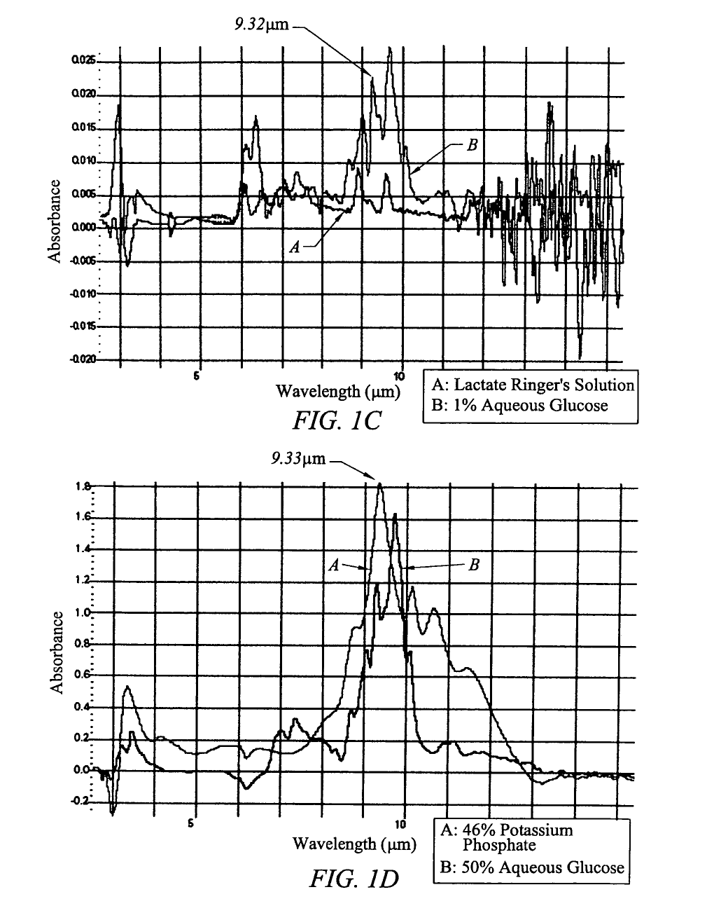

With respect to coherent or incoherent infrared electromagnetic radiation, it should be understood that, as discussed in greater detail below, an organic substance has an infrared absorption spectrum which includes a set (n) of wavelength regions with each wavelength region corresponding to an absorption band of the absorption spectrum. For example, FIG. 1 shows the infrared absorption spectrum of distilled water alone (see curve A) and 0.5% glucose in distilled water (see curve B). FIG. 1 also shows the infrared absorption spectrum of lactated ringers solution (LRS) alone (see curve C) and 0.5% glucose in LRS (see curve D). Note that LRS contains lactate, sodium, potassium, calcium, and chloride ions and is used, for example, in the rehydration of animals in an emergency. LRS is utilized herein to mimic various biological fluids, including, but not limited to, capillary filtrate collector fluid. Other clinical biological fluids the methods described herein can be utilized with include, but are not limited to, saliva, tears, and urine, and blood components, such as plasma. However, it should be understood that the methods described herein are not limited to just biological samples, such as biological fluids, but can be utilized to measure the amount of an organic substance in other various types of samples.

As shown in FIG. 1, absorption of the infrared electromagnetic radiation by glucose is seen in the about 1200 cm⁻¹ to about 950 cm⁻¹ range of the spectrum. In particular, the infrared absorption spectrum of FIG. 1 shows absorption bands centered at about 1107 cm⁻¹, about 1080 cm⁻¹, about 1035 cm⁻¹, about 1150 cm⁻¹, and about 993 cm⁻¹ for glucose dissolved in distilled water and for glucose dissolved in LRS. Accordingly, glucose has a set (n) of absorption bands within the about 1200 cm⁻¹ to about 950 cm⁻¹ range of the spectrum. In this case (n) equals 5, i.e., an absorption band centered at about 1107 cm⁻¹, about 1080 cm⁻¹, about 1035 cm⁻¹, about 1150 cm⁻¹, and about 993 cm⁻¹. It should be appreciated that, as shown in FIG. 1, at least a portion of each absorption band occurs between two selected wavenumbers. For example, the absorption band centered at about 1107 cm⁻¹ occurs between wavenumbers about 1094 cm⁻¹ and about 1118 cm⁻¹. It should be understood that the area of the spectrum between two wavenumbers, at which an absorption band occurs, is referred to herein as a wavelength region. As such, each absorption band has a substantially corresponding selected wavelength region. For example, the absorption band at about 1107 cm⁻¹ has a substantially corresponding wavelength region of about 1094 cm⁻¹ to about 1118 cm⁻¹. In a similar manner, the absorption band at about 1080 cm⁻¹ has a substantially corresponding wavelength region of about 1075 cm⁻¹ to about 1090 cm⁻¹. The absorption band at about 1035 cm⁻¹ has a substantially corresponding wavelength region of about 1018 cm⁻¹ to about 1048 cm⁻¹. The absorption band at about 1150 cm⁻¹ has a substantially corresponding wavelength region of about 1137 cm⁻¹ to about 1175 cm⁻¹. The absorption band at about 993 cm⁻¹ has a substantially corresponding wavelength region of about 983 cm⁻¹ to about 1003 cm⁻¹. Therefore, it should be appreciated that each absorption spectrum also has a set (n) of wavelength regions, and since each absorption band has a substantially corresponding wavelength region, the set (n) of wavelength regions equals the set (n) of absorption bands. For example, with respect to the absorption spectrum of glucose shown in FIG. 1, the set (n) of absorption bands equals 5 and accordingly the set (n) of wavelength regions also equals 5.

As discussed above, the glucose absorption spectrum of FIG. 1 has 5 absorption bands respectively centered at about 1107 cm⁻¹, about 1080 cm⁻¹, about 1035 cm⁻¹, about 1150 cm⁻¹, and about 993 cm⁻¹. It should be appreciated that glucose not only absorbs infrared electromagnetic radiation at each particular wavenumber mentioned above, but also at higher and lower wavenumbers around each of the aforementioned centered wavenumbers. In other words, an absorption band of an organic substance (e.g., glucose) has a width, and therefore will absorb a range or a wavelength band of infrared electromagnetic radiation. As discussed above, a wavelength region is the area of the spectrum between two wavenumbers at which an absorption band occurs. Accordingly, a wavelength band is the range of wavenumbers (or other methods of measuring electromagnetic radiation including, but not limited to, frequency or wavelengths) within a wavelength region at which an organic substance absorbs electromagnetic radiation. In other words, each wavelength band substantially corresponds to a wavelength region. For example, as previously mentioned, the absorption spectrum of glucose shown in FIG. 1, has 5 wavelength regions, i.e., (i) about 1094 cm⁻¹ to about 1118 cm⁻¹, (ii) about 1075 cm⁻¹ to about 1090 cm⁻¹, (iii) about 1018 cm⁻¹ to about 1048 cm⁻¹, (iv) about 1137 cm⁻¹ to about 1175 cm⁻¹, and (v) about 983 cm⁻¹ to about 1003 cm⁻¹. Therefore, the absorption spectrum of glucose shown in FIG. 1 also has 5 substantially corresponding wavelength bands at which glucose absorbs the electromagnetic radiation, i.e., (i) about 1094 cm⁻¹ to about 1118 cm⁻¹, (ii) about 1075 cm⁻¹ to about 1090 cm⁻¹, (iii) about 1018 cm⁻¹ to about 1048 cm⁻¹, (iv) about 1137 cm⁻¹ to about 1175 cm⁻¹, and (v) about 983 cm⁻¹ to about 1003 cm⁻¹. However, note that a wavelength region and a wavelength band do not necessarily have to be a range if the organic substance of interest and the nature of the electromagnetic radiation is such that a single wavenumber (frequency or wavelength) can be utilized in the methods described herein. Therefore, as used herein, the terms “wavelength region” and “wavelength band” can be a range or can consist of a single wavenumber (frequency or wavelength). It should also be understood that, while examples of the methods described herein utilize incoherent infrared electromagnetic radiation, coherent infrared electromagnetic radiation can also be utilized.

Still referring to FIG. 1, it should be understood that the glucose absorption spectrum shown therein has a number of reference wavelength bands as well. A reference wavelength band is similar to one of the above described wavelength bands, however in contrast to a wavelength band, a reference wavelength band is a range of wavenumbers at which (i) the organic substance of interest does not substantially influence the electromagnetic radiation but other compounds present within the biological sample do influence the electromagnetic radiation or (ii) no organic substance present within the biological sample substantially influences the electromagnetic radiation. For example, a range of wavenumbers at which the organic substance of interest does not substantially absorb infrared electromagnetic radiation, while other organic substances present in the biological sample do absorb infrared electromagnetic radiation, can be utilized as a reference wavelength band in the methods described herein. In addition, a range of wavenumbers at which no organic substance present in the biological fluid substantially absorbs infrared electromagnetic radiation can be utilized as a reference wavelength band in the methods described herein. In particular, the organic substance of interest with respect to the absorption spectrum shown in FIG. 1 is glucose, accordingly potential wavenumber ranges which can serve as reference wavelength bands are (i) those wavenumber ranges at which glucose substantially does not absorb the infrared electromagnetic radiation while other compounds present in the sample do absorb the infrared electromagnetic radiation and (ii) those wavenumber ranges at which no organic substance substantially absorbs the infrared electromagnetic radiation. Preferably, a reference wavelength band is selected where no organic substance substantially influences or absorbs the electromagnetic radiation; however this is not necessary for the performance of the methods described herein.

Selecting a reference wavelength band having the above described characteristics allows the spectral data (e.g., absorbance) obtained from detecting electromagnetic radiation within a particular reference wavelength band to be utilized as a baseline measurement. This baseline measurement data is also processed with the aforementioned mathematical model to obtain a measurement of the amount of the organic substance of interest present within the biological sample. Two specific examples of reference wavelength bands are shown in FIG. 1, i.e., one at about 1090 cm⁻¹ to about 1095 cm⁻¹ and another one at about 1170 cm⁻¹ to about 1180 cm⁻¹.

To provide a measurement of the amount (e.g., the concentration) of an organic substance contained within a biological sample, the biological sample is illuminated with electromagnetic radiation, such as infrared electromagnetic radiation. For example, a beam of incoherent infrared electromagnetic radiation can be passed through a biological fluid, such as capillary filtrate fluid, so that the organic substance of interest contained within the biological fluid influences the electromagnetic radiation. Preferably, the organic substance contained within the biological fluid absorbs the electromagnetic radiation so as to create an absorption spectrum which, as discussed above, includes a set (n) of wavelength regions where each of the wavelength regions substantially correspond to an absorption band of the absorption spectrum. After illuminating the biological sample with the electromagnetic radiation, the intensity (e.g., detecting the transmittance) of the wavelength bands and reference wavelength bands are detected with a detection system. In particular, it should be understood that the intensity of only the wavelength bands and the reference bands are detected with the detection system. Furthermore, it should be understood that not all of the wavelength bands and reference wavelength bands are detected. In particular, only a select number of wavelength bands of the absorption spectrum are detected along with only a select number of reference wavelength bands. Therefore, it should be appreciated that only the selected wavelength bands and reference wavelength bands are detected with the detection system while the rest of the electromagnetic radiation is substantially prevented from being detected by the detection system. For example, the electromagnetic radiation not included in the selected wavelength bands and reference wavelength bands can be substantially filtered out prior to reaching the detection system. In other words, the detection of the wavelength bands and reference wavelength bands is restricted to a select number of wavelength bands of electromagnetic radiation and a select number of reference wavelength bands of electromagnetic radiation. In particular, the number of selected wavelength bands of electromagnetic radiation is equal to n−1 or less. That is, the number of selected wavelength bands of electromagnetic radiation is a subset of (n).

With respect to which particular wavelength band, or combination of wavelength bands, is/are selected for detection is dependent upon which wavelength band(s), in combination with the selected reference wavelength band(s), yields spectral data for processing with a mathematical model so as to provide a useful measurement of the amount of organic substance contained within the biological sample. What is meant herein by “useful” measurement is that the measurement of the amount of organic substance contained with the biological sample is accurate and/or precise enough such that it would be acceptable to utilize in a particular measurement, assay, or application. For example, if a method described herein is utilized in providing a measurement of the amount of glucose contained within capillary filtrate fluid of a diabetic patient, the wavelength band(s) and reference wavelength band(s) must be selected so that the spectral data supplied to the mathematical model from the combination of these bands results in a glucose measurement that is accurate and/or precise enough such that it informs the patient as to his or her glucose levels within acceptable limits.

Factors to consider when selecting which wavelength band(s) to detect include for example (i) ensuring that the absorption band contained within the wavelength band is, or includes, an absorption band of the organic substance of interest, (ii) selecting a wavelength band which has relatively strong absorption, and (iii) selecting a wavelength band where the strength of the wavelength band correlates well with the amount of organic substance of interest contained in the biological sample. In addition, it is preferable that the selected wavelength band(s) is relatively free of interference from absorption bands caused by substances other than the organic substance of interest present in the sample (e.g., the selected wavelength band is separated from the wavelength band of the potentially interfering substance). However, it should be understood that in order to utilize the methods described herein, the selected wavelength band(s) does not have to be free of interfering absorption bands caused by substances other than the organic substance of interest. Accordingly, a selected wavelength band(s) may be relatively free of interference from absorption bands caused by substances other than the organic substance of interest, or the selected wavelength band(s) may include interfering absorption bands caused by substances other than the organic substance of interest. Therefore, it should be appreciated that the selected wavelength band(s) can (i) be relatively free of interference from absorption bands caused by substances other than the organic substance of interest present in the sample, (ii) include interfering absorption bands caused by substances other than the organic substance of interest present in the sample, or (iii) be a combination of selected wavelength bands in which some are relatively free of interference from absorption bands caused by substances other than the organic substance of interest while others include interfering absorption bands caused by substances other than the organic substance of interest.

Furthermore, the particular mathematical model (e.g., algorithm) and wavelength band(s) and reference wavelength band(s) selected for a particular sensor configuration (discussed below) are determined by the performance of the calibration procedure (discussed below) used for a specific biological sample. Moreover, in order to obtain a useful measurement from a particular sensor configuration, the mathematical model, selected wavelength band(s), and selected reference wavelength band(s) may differ depending upon the nature of the biological sample the organic substance of interest is contained within. For example, different selected wavelength band(s) and selected reference wavelength band(s), in addition to a different mathematical model may be needed depending upon whether the organic substance is contained within for example, plasma or capillary filtrate fluid. Additional factors to consider are measurement accuracy requirements and the economics of the electromagnetic radiation source, optical filters, and detection elements. It should be appreciated that each of the aforementioned factors for a particular application of the methods described herein can be determined by one of ordinary skill in the art by routine experimentation.

After identifying wavelength bands that meet one or more of the aforementioned criteria, which wavelength bands are actually selected for detection and utilization in one of the methods described herein is determined. In particular, different combinations of wavelength bands, or a single wavelength band, along with one or more reference wavelength bands are utilized until it is determined which combination yields a useful measurement.

The detection system generates an electrical signal as a result of detecting the intensity of the selected wavelength band(s) and reference wavelength band(s). The electrical signal is processed to yield data which is utilized to provide a useful measurement of the amount of the organic substance of interest contained within the biological sample. For example, data generated by the electrical signal can be processed by a mathematical model, such as a quantification algorithm, so as to provide a useful measurement of the amount of the organic substance of interest contained within the biological sample.

It should be appreciated that detecting and processing spectral data only from the selected wavelength band(s) and reference wavelength band(s) simplifies the process of providing a useful measurement of the amount of an organic substance of interest contained within a biological sample. For example, since an apparatus for performing a method described herein only detects and processes spectral data from a select number of wavelength bands and reference wavelength bands it is less complex as compared to an apparatus configured to detect and process spectral data from all of the wavelength bands of an absorption spectrum. Accordingly, an apparatus configured to perform one of the methods described herein lends itself to being smaller, compact and portable.

While the above description is directed to the preferred method of limiting the detection to select wavelength bands and reference wavelength bands, an alternative embodiment of a method for measuring an amount of an organic substance contained within a biological sample is to detect all of the wavelength bands, but only process the spectral data from the aforementioned selected wavelength bands with the mathematical model.

Other alternative embodiments of the present invention may be utilized to mitigate, minimize and/or remove the deleterious impact caused by interfering compounds in the accurate measurement and quantification of a biological sample of interest. As used herein, an interfering compound or interferent refers to any compound, material or substance present in a biological sample that is spectrally active in the measurement wavelength or range of wavelengths used or selected to quantify or measure the material of interest. The adverse impact caused by interfering compounds may be countered using a number of techniques, alone or in combination as described below. Every biological sample of interest will have its own unique absorbance spectra that will be used to identify the wavelength bands useful in quantifying the sample as described above. As a result, the classification of a material as an interfering compound will vary depending upon the biological sample of interest and the spectra selected to quantify that biological sample of interest.

Interfering compounds may be removed by physical filtration. When physical filtration is desired, the biological sample of interest or material of interest is passed through a filter that has been sized to remove interfering compounds and allow the passage of the material of interest. Physical filtration is particularly useful when the size of interfering compound molecules are larger than the molecules in the biological material of interest. Another technique to overcome the adverse impact of interfering compounds is through careful selection and filtering of the radiation or signaling used to measure the biological material of interest. The effect of the interfering compounds may be minimized or eliminated by selecting portions of the spectra of the biological material of interest that are measurably distinct from the absorption spectra of the interfering compound or compounds. Unlike physical filtration where the interfering compound is removed from the sample, in this technique the interfering compound remains in the sample but it's impact is mitigated through careful selection of the spectra used for quantification and measurement of the biological material of interest. Another technique for mitigating the effect of interfering compounds is the application of mathematical signal processing algorithms to the spectral data collected from the biological sample of interest. The mathematical signal processing algorithms of the present invention are described in greater detail above and below. Embodiments of the mathematical signal processing algorithms of the present invention are particularly useful, for example, when it is desired to remove the spectra created by an interfering compound from the spectra of the biological material of interest even when those spectra exist in the same wavelength range. Each of the above techniques has been described alone for clarity. It is to be appreciated that embodiments of the interfering compound removal techniques of the present invention may be used to advantage alone or in any combination.

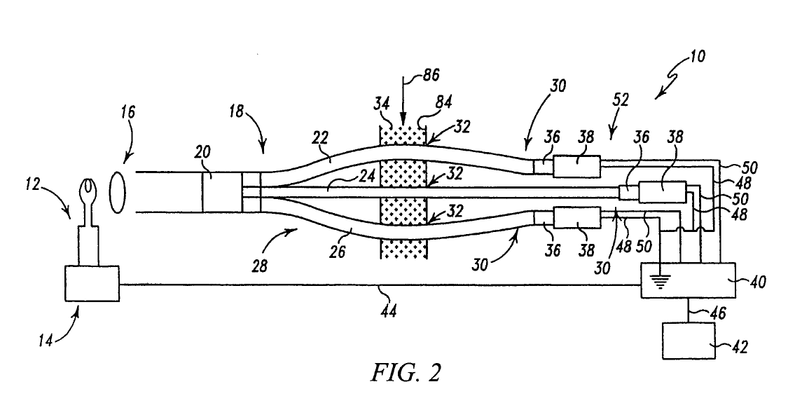

For purposes of illustration and not limitation, the above described interfering compound removal techniques for removing or mitigating the effect of an interfering compound will be described with reference to FIGS. 1A through 1D. The techniques have application to any measurement techniques such as reflective, evanescent wave, or transmission based measurement or other technique described below in the regard to FIGS. 2-5. In the following examples, the biological material of interest is glucose. Accordingly, of particular interest is the identification of compounds that have features in the 8-10 micron range of the infrared spectrum where several large magnitude glucose absorbance bands are found. While the examples that follow may refer to a single or only a few of the glucose absorbance bands, it is to be appreciated that the techniques described herein are not limited to the particular absorbance band discussed. Compounds that are spectrally active in the 8 μm to 10 μm wavelength range are likely interfering compounds that should be addressed so that the glucose spectra are detected more readily. The specific wavelengths of interest that are useful in some embodiments of the present invention are a so-called ‘Interference Wavelength’ centered at about 7.93 μm having a bandwidth of about 0.16 μm; a so-called ‘Baseline Wavelength’ centered at about 8.33 μm having a bandwidth of about 0.14 μm; a ‘Glucose Wavelength’ centered at about 9.32 μm having a bandwidth of about 0.40 μm and a so-called “Reference Wavelength” centered at about 3.95 μm having a bandwidth of about 0.09 μm. A number of compounds that are likely to serve as potential interferents in glucose measurements in biological samples are reviewed.

FIG. 1A is graph of the absorbance spectra for a commercially available 8.5% amino acid solution and a 10% aqueous solution of glucose. The spectrum for the glucose solution is labeled B on the graph. The amino acid solution is commercially available from Baxter under the trade name “Travasol.” The spectrum for the amino acid solution is labeled A on the graph. As shown in the graph, the major absorbance peaks for the 8.5% amino acid solution occur at about 6.26 μm, 7.08 μm, 6.58 μm, 3.37 μm and 7.50 μm. This example illustrates the point that if glucose is measured using the peak absorbance spectra between about 9 μm and 10 μm, then amino acids would not be considered an interfering compound. However, if for some reason it was desirous to measure glucose using the absorbance peaks between 6 μm and 8 μm, then amino acids would be considered an interfering compound.

FIG. 1B is graph of the absorbance spectra for micro-filtered human plasma (line A), 1% aqueous glucose solution (line B), and ultra-filtrated human plasma (line C). The micro-filtered human plasma is donor-grade human plasma obtained from US Biological. The micro-filtered human plasma was filtered through 0.2 μm SFCA syringe filter prior to measurement. EDTA was present as a preservative. The micro-filtered human plasma is known to contain about 90% water and about 10% dissolved proteins, which include coagulation factors that, under certain conditions, may produce a precipitate known as “cryoprecipitate.” As illustrated, the micro-filtered human plasma absorbance peaks occur, in decreasing order of magnitude, at 6.47 μm, 6.05 μm, 7.14 μm, 6.87 μm, and 7.60 μm. Of particular interest is the strength of the absorbance signal present in the 9 μm to 10 μm range. While the main absorbance peaks appear not to interfere with glucose measurement in the 9 μm to 10 μm range, the presence of such a high magnitude absorbance signal may still interfere with accurate glucose measurement. Contrast the micro-filtered human plasma absorbance spectra to the ultra-filtrated human plasma (Line C). The ultra-filtration human plasma had been passed through a ultrafiltration membrane having a cut-off at 30 k Dalton (kD) using a commercially available ultrafiltration membrane. As illustrated, the ultra-filtrated human plasma absorbance peaks occur, in decreasing order of magnitude, at about 6.32 μm, about 6.12 μm, about 6.05 μm, about 7.13 μm and about 7.35 μm. It is important to note that the primary absorbance peaks are similar to those in the microfiltrated human plasma, but the absorbance magnitude has been reduced by about one-tenth. More importantly, the magnitude of the absorbance signal present in the glucose measuring range (i.e., 9 μm to 10 μm range) has been diminished to a level well below that of the glucose signal, even using a low magnitude signal such as that obtained from a 1% aqueous glucose sample. Thus, FIG. 1B illustrates how the use of appropriately sized physical filtration (i.e., ultrafiltration instead of microfiltration) may be used to minimize the impact of a material on glucose measurement.

FIG. 1C is graph of the absorbance spectra for a lactate ringer's solution (LRS) (Line A) and a 1% aqueous glucose solution (line B). The LRS solution contains sodium lactate (0.3%) and chlorides of sodium (0.6%), potassium (0.03%) and calcium (0.02%). The LRS absorbance spectrum has multiple peaks because of the presence of the other salts. It is believed that the sodium lactate absorbance peaks occur, in decreasing order of magnitude, at about 6.34 μm, about 8.89 μm, about 9.59 μm, and about 7.61 μm. In this case, the sodium lactate has a number of absorbance peaks in close proximity to some of the glucose absorbance peaks. However, in this example, the likelihood of interference from the LRS solution is diminished by advantageously selecting the glucose peak centered at about 9.32 μm. The selection of a particular spectra of interest is accomplished, for example, through the optimal selection of an IR emitter having a radiation signal in the wavelength range of interest (here, mid infrared) alone or in combination with the use of a detector with filters for the wavelength or wavelength range of interest. As a result of this technique, the LRS spectrum has little or no impact on detecting and measuring glucose, thereby increasing the accuracy and ease of measuring the glucose spectra. Thus, the advantageous combination of selection of a particular wavelength for glucose monitoring and selective filtering of the absorbance spectra may be employed to obtain glucose measurements more readily and accurately.

FIG. 1D is graph of the absorbance spectra for a solution containing potassium phosphate (Line A) and a 50% aqueous glucose solution (line B). Potassium phosphate has absorbance peaks, in decreasing order of magnitude, at about 9.33 μm, about 10.12 μm, about 10.65 μm, and about 3.33 μm. Potassium phosphate is a good example of another type of interfering substance. The potassium phosphate spectrum has a large magnitude in the glucose range (i.e., 9 μm to 10 μm) and a wide bandwidth. The result is an interfering spectrum that is both stronger than the nearby glucose spectra and also has a wide enough bandwidth to interfere with nearly all of the desired glucose absorbance peaks. The glucose interference problems presented by the potassium phosphate spectra may be handled using the mathematical signal processing algorithms described above and below. As a result, the sample absorbance spectrum is measured, and the undesired impact of the potassium phosphate is removed during post processing. It is to be appreciated that the potassium phosphate absorption spectra as an interfering compound is used for purposes of illustration and not limitation. The technique described above and elsewhere relating to the use of signal processing algorithms to remove unwanted or interfering spectra may be used with other interfering compounds and with other measurement techniques and systems such as those illustrated in FIGS. 2-5.

Now referring to FIG. 2, there is shown an example of a fiber optic evanescent wave sensor 10 which can be utilized in the methods described herein. In particular, the spectral data obtained from this type of sensor 10 can be utilized in the quantification of an organic substance contained in a biological fluid. A fiber optic evanescent wave sensor of the type shown in FIG. 2 is described by Karlowatz, M., Kraft, M., Eitenberger, E., Mizaikoff, B. and Katzir, A. in “Chemically Tapered Silver Halide Fibers: An Approach for Increasing the Sensitivity of Mid-Infrared Evanescent Wave Sensors,” Applied Spectroscopy, 54(11), pp. 1629-1633 (2000), which is incorporated herein by reference. Another fiber optic evanescent wave sensor of the type shown in FIG. 2 is described by Han, L., Lucas, D., Littlejohn, D., and Kyauk, S. in “NIR Fiber-optic Method with Multivariate Calibration Analysis for Determination of Inorganic Compounds in Aqueous Solutions,” Applied Spectroscopy, 54(10), pp. 1447-1452 (2000), which is also incorporated herein by reference.

Briefly, sensor 10 shown in FIG. 2 includes a number of optic fibers, for example sensor 10 can include an optical fiber bundle 18 having a coupler 20 which splits into optical fibers 22,24, and 26. The number of optical fibers sensor 10 includes is determined by the number of selected wavelength bands and reference wavelength bands utilized in determining the amount of the organic substance contained in the biological fluid. For example, sensor 10 includes 3 optical fibers, one for a first selected wavelength band, one for a second selected wavelength band, and one for a reference wavelength band. Sensor 10 also includes a modulated infrared source 12, a regulated power supply 14, and focusing optics 16 which focuses the modulated infrared beam into optical fiber bundle 18 and thus into optical fibers 22,24, and 26. Sensor 10 further includes filters 36, a detection system 52 having a number of detection elements 38, a mode-lock amplifier 40, and a signal processor 42.

Modulated infrared source 12 and signal processor 42 are electrically coupled to mode-lock amplifier 42 via electrical lines 44 and 46, respectively. In addition, each detection element 38 is electrically coupled to mode-lock amplifier 42 via an electrical line 48 and an electrical line 50. A receiving end 30 of each optical fiber 22, 24, and 26 is operatively coupled to a filter 36, which in turn is operatively coupled to a detection element 38. Note that optic fibers 22,24, and 26 are unclad through a portion of their length where biological fluid 34 flows over the fiber. The length of this portion is determined by the signal-to-noise ratio requirements. In sensor 10 the transmitting and receiving ends are continuous, i.e., made of the same fibers. The attenuation or absorbance of electromagnetic radiation advanced through optic fibers 22,24, and 26 due to the organic substances contained within biological fluid 34 takes place via the aforementioned evanescent wave phenomenon. Note that filters 36 are optical band-pass filters that limit the range of wavelengths of electromagnetic radiation which pass there through. In particular, filters 36 are configured so that only the select wavelength bands and the select reference wavelength band are allowed to substantially pass there through and thus be detected by detection elements 38.

When operating sensor 10 power supply 14 provides power to infrared source 12 such that infrared source 12 generates a beam of incoherent infrared electromagnetic radiation directed toward focusing optics 16. Focusing optics 16 focuses the radiation onto coupler 20 which in turn directs the radiation through fiber bundle 18. Specifically, the radiation is transmitted through optic fibers 22,24, and 26, and thus pass through biological fluid 34 as biological fluid 34 is advanced through a sample cell 84 in the direction indicated by arrow 86. Certain wavelengths of the radiation are absorbed by organic substances contained within biological fluid 34 as the radiation passes there through. After passing through biological fluid 34 the radiation interacts with filters 36. As discussed above, filters 36 restrict the infrared electromagnetic radiation allowed to substantially pass there through to the selected wavelength bands and the selected reference wavelength band. Each selected wavelength band and the selected reference wavelength band interacts with a detection element 38. Each detection element 38 generates an electrical signal in response to interacting with a wavelength band or the reference wavelength band. The electrical signal is communicated to mode-lock amplifier 40 via the aforementioned electrical lines. Each electrical signal is then communicated to processor 42 (such as an integrated circuit) via electrical line 46. Processor 42 then processes the electrical signals with a mathematical model, such as a quantification algorithm, so as to provide a useful measurement of the amount of the organic substance of interest (e.g., glucose) contained within biological fluid 34.

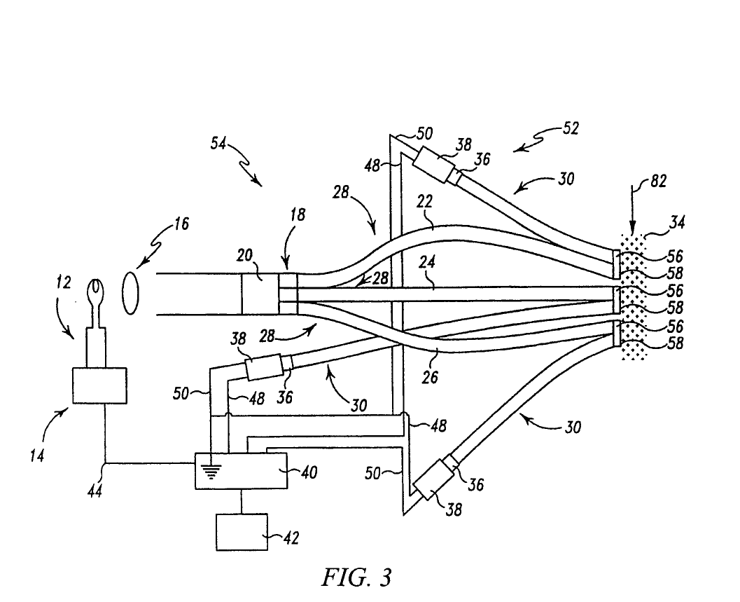

Now referring to FIG. 3, there is shown an example of an attenuated total reflection (ATR) fiber optic evanescent wave sensor 54 which can be utilized in the methods described herein. Sensor 54 is substantially similar to sensor 10 described above and thus the same reference numbers are used to indicate the corresponding components. In addition, since sensor 54 is similar to sensor 10 and operates in a similar manner, only substantial differences between sensor 54 and sensor 10 are briefly discussed herein.

As previously mentioned, the construction of sensor 54 is similar to sensor 10 except that transmitting ends 28 and receiving ends 30 of fibers 22,24, and 26 are separate units and they both terminate at an ATR crystal 56 operatively coupled to one end thereof. Fluid 34 is in contact with each ATR crystal surface 58 but does not come in contact with optical fibers 22,24, and 26 as fluid 34 flows past ATR crystal surfaces 58 in the direction indicated by arrow 82.

Sensor 54 is also based on the evanescent wave principle mentioned above. However, with sensor 54 the evanescent wave penetrates into fluid 34 via ATR crystals 56 which are kept in contact with fluid 34. The electrical signals are generated and processed in a manner similar to that discussed above in reference to sensor 10.

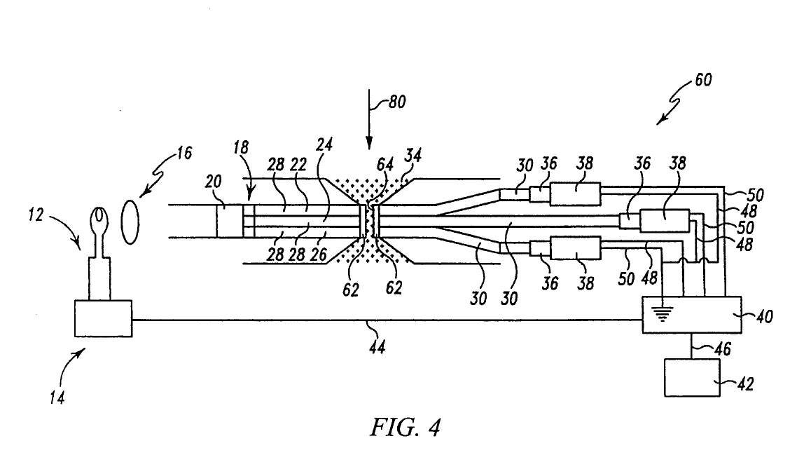

Now referring to FIG. 4, there is shown an example of a fiber optic injection transmission sensor 60 which can be utilized in the methods described herein. Sensor 60 is substantially similar to sensor 10 described above and thus the same reference numbers are used to indicate the corresponding components. In addition, since sensor 60 is similar to sensor 10 and operates in a similar manner, only substantial differences between sensor 60 and sensor 10 are briefly discussed herein.

A fiber optic fluid injection transmission sensor of the type shown in FIG. 4 is described by Lendl, B., Schindler, R., Frank, J., and Keilner, R. (1997), in “Fourier Transform Infrared Detection in Miniaturized Total Analysis Systems for Sucrose Analysis,” Analytical Chemistry, 69(15), pp. 2877-2881 (1997) which is incorporated herein by reference. Briefly, transmitting ends 28 and receiving ends 30 of optical fibers 22, 24, and 26 terminate at infrared transmitting windows 62 which are positioned tens of microns apart. Transmitting windows 62 define a biological sample cell 64 (for example about 10 microns wide). Biological fluid 34 is positioned within, or flows through (in the direction indicated by arrow 80), sample cell 64 which defines the pathlength for the infrared absorption.

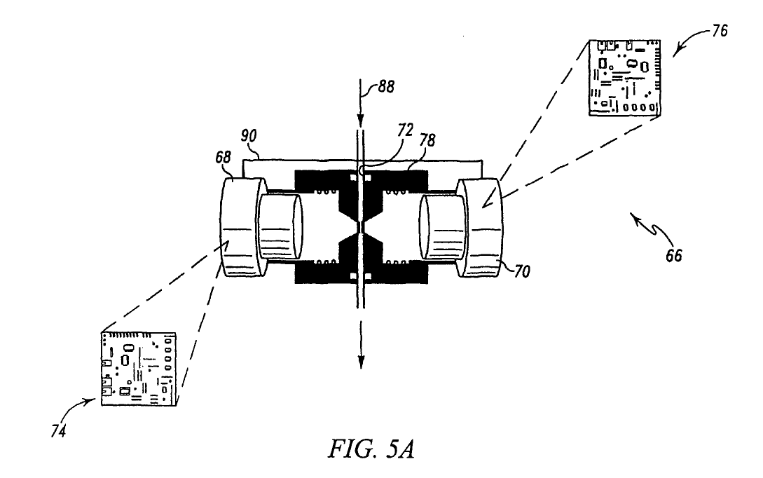

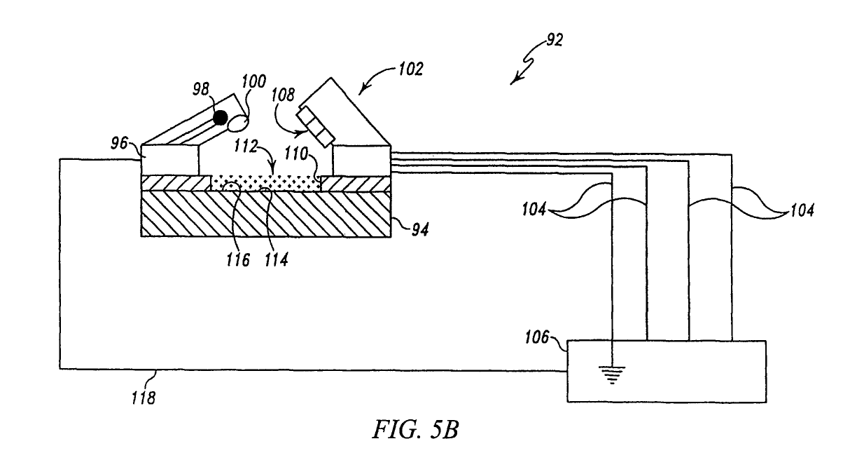

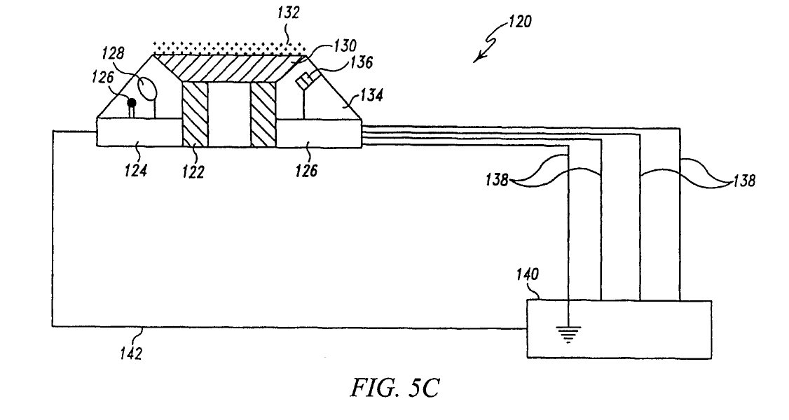

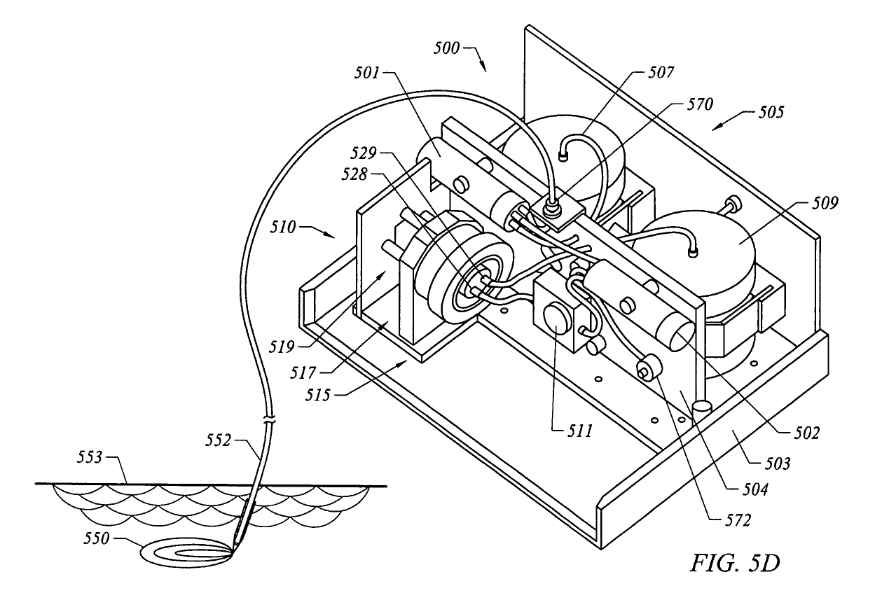

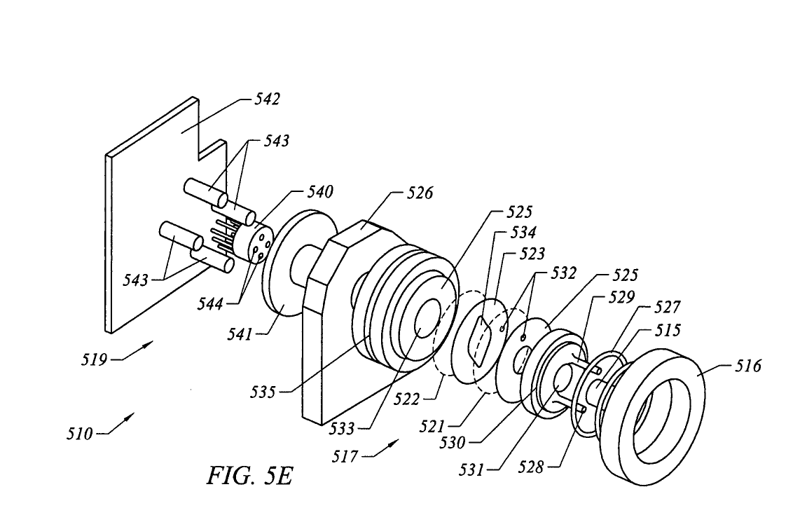

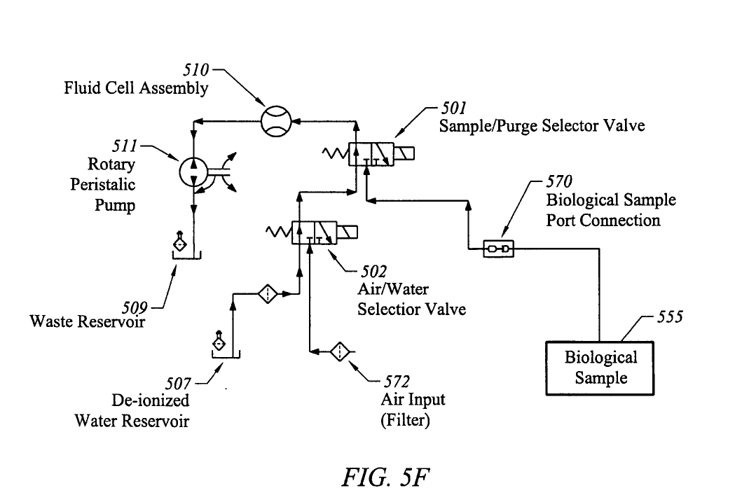

Now referring to FIG. 5A, there is shown another example of a sensor 66 which can be utilized in the methods described herein. Sensor 66 includes a miniature pulsable infrared emitter source 68 with a parabolic reflector. An example of a miniature pulsable infrared emitter source 68 which can be utilized with the methods described herein is commercially available from Ion Optics, which is located in Waltham, Mass. Source 68 includes an electrically coupled infrared source power supply and modulator circuit 74. An example of a power supply and modulator circuit 74 which can be utilized with the methods described herein is commercially available from Boston Electronics, located in Brookline, Mass. Sensor 66 also includes a multi-channel miniature pyroelectric infrared detector 70. Detector 70 includes an electrically coupled pyroelectric detector preamplifier and signal processing circuit 76. An example of a multi-channel miniature pyroelectric infrared detector 70 which can be utilized with the methods described herein is commercially available from InfraTec GmbH, located in Dresden, Germany. Additional infrared detectors which can be utilized in the methods described herein are commercially available from Wilkes Enterprise, Inc. located in South Norwalk, Conn. Sensor 66 further includes a biological sample cell 78 interposed between source 68 and detector 70. Cell 78 has a sample space 72 defined therein so that a biological fluid can be advanced there through in the direction indicated by arrow 88. For example, a biological fluid such as capillary filtrate collected from a capillary filtrate collector. One capillary filtrate collector which can be utilized in the methods described herein is described by Ash S. R. et al. in U.S. Pat. No. 4,777,953 issued, Oct. 18, 1988 entitled “Capillary filtration and collection method for long-term monitoring of blood constituents,” U.S. Pat. No. 4,854,322 issued, Aug. 8, 1989 entitled “Capillary Filtration Collection Device for Long Term Monitoring of Blood Constituents,” U.S. Pat. No. 5,002,054 issued, Mar. 26, 1991 entitled “Interstitial Filtration and Collection Device and Method for Long-Term Monitoring of Physiological Constituents of the Body,” and “Subcutaneous Ultrafiltration Fibers for Chemical Sampling of Blood: The Capillary Filtrate Collector (CFC)” in Leung W W-F. ed. Proceedings of the National Meeting of the American Filtration Society. Chicago: Advances in Filtration and Separation Technology, Vol. 7, 1993:316-319, which are incorporated herein by reference. The Capillary Filtrate Collector (CFC) contains three looped hollow fiber ultrafiltration membranes (pan, 30,000 mw cutoff) placed into the subcutaneous space (FIG. 1). When placed under vacuum, these fibers create an ultrafiltrate which passes from surrounding capillaries, through the fibers, into a polyurethane tubing surrounded by a 2 mm expanded PTFE cuff, through the skin, past a “Y” connector with one limb leading to a sampling port, and through a hub and needle into a Vacutainer® providing 55 mm vacuum. Gas also is drawn from the capillaries, creating spaces between ultrafiltrate samples as they move through the tubing. Animal studies have confirmed that the concentration of glucose within the CFC ultrafiltrate is exactly the same as the plasma free water concentration when the filtrate is created. The same is true for a variety of drugs and organics of less than 3000 molecular weight. During operation of sensor 66, source 68 generates a low frequency infrared electromagnetic radiation pulse. Circuit 74 is configured to optimize the signal-to-noise ratio of the pulse reaching the biological fluid contained within sample space 72. The radiation is transmitted through sample space 72 and thus passes through the biological fluid contained therein. As previously discussed, certain wavelengths of the radiation are absorbed by organic substances contained within the biological fluid 34 as the radiation passes there through. The radiation then interacts with detector 70 which is configured so that only the select wavelength bands and the select reference wavelength band are substantially detected by detector 70. Upon detecting the select wavelength bands and the select reference wavelength band an electrical signal is sent to circuit 76 which processes the electrical signal with a mathematical model to provide a useful measurement of the amount of the organic substance of interest contained within the biological fluid. Note that circuit 76 has a frequency synchronization connection 90 that ensures that high signal-to-noise ratios are maintained through modulated signal detection.

Now referring to FIG. 5B, there is shown still another example of a sensor 92 which can be utilized in the methods described herein. In particular, sensor 92 is a reflection-absorption based infrared sensor. Briefly sensor 92 includes a base 94 having a receptacle area 110 defined therein. Receptacle area 110 has a floor 114 with a reflective surface 116 defined thereon. Sensor 92 also includes a regulated power supply 96 operatively coupled to base 94. Sensor 92 further includes a modulated infrared source 98 and focusing optics 100. Modulated infrared source 98 is operatively coupled to power supply 96 and focusing optics 100. In addition, modulated infrared source 98 and focusing optics 100 are positioned relative to receptacle area 110 such that infrared electromagnetic radiation generated by modulated infrared source 98 is directed onto receptacle area 110 by focusing optics 100. Sensor 92 also includes a detection element 102 operatively coupled to a filter assembly 108. Detection element 102 is operatively coupled to base 94 such that infrared electromagnetic radiation reflected off of reflective surface 116 impinges onto filter assembly 108 and detection element 102. Sensor 92 further includes a mode-lock amplifier 106 which is operatively coupled to detection element 102 and power supply 96 via electrical lines 104 and electrical line 118, respectively.

When operating sensor 92 power supply 96 provides power to infrared source 98 such that infrared source 98 generates a beam of infrared electromagnetic radiation directed toward focusing optics 100. Focusing optics 100 directs the radiation through a fluid film 112 positioned within receptacle area 110. The radiation is transmitted through fluid film 112 and is reflected off of reflective surface 110 so that it interacts with filter assembly 108. As discussed above, certain wavelengths of the radiation are absorbed by organic substances contained within fluid film 112 as the radiation passes there through. As discussed above, filter assembly 108 restricts the infrared electromagnetic radiation allowed to substantially pass there through to the selected wavelength bands and the selected reference wavelength band. Each selected wavelength band and the selected reference wavelength band interacts with a detection element 102 which generates an electrical signal in response to interacting with a wavelength band or the reference wavelength band. The electrical signal is communicated to mode-lock amplifier 106 via the aforementioned electrical lines. Each electrical signal is then communicated to a processor (such as an integrated circuit; not shown) via an electrical line (not shown). The processor then processes the electrical signals with a mathematical model, such as a quantification algorithm, so as to provide a useful measurement of the amount of the organic substance of interest (e.g., glucose) contained within fluid film 112.

Now referring to FIG. 5C there is shown an example of a miniature ATR sensor 120 which can be utilized in the methods described herein. Sensor 120 includes a base 122, a regulated power supply 124 operatively coupled to base 122 and a detector signal conditioning and amplification circuit 126 also operatively coupled to base 122. Sensor 120 further includes an infrared source 126 and focusing optics 128 operatively coupled to power supply 124. Infrared source 126 and focusing optics 128 are positioned relative to an ATR crystal 130 so that infrared electromagnetic radiation generated by infrared source 126 is directed through ATR crystal 130 and into a sample 132 by focusing optics 128. Sensor 120 also includes a detection element 134, such as a multichannel detector, operatively coupled to a filter assembly 136. Detection element 134 is positioned relative to ATR crystal 130 such that infrared electromagnetic radiation being emitted through ATR crystal 130 impinges onto filter assembly 136 and detection element 134. Sensor 120 further includes a mode-lock amplifier 140 which is operatively coupled to detector signal conditioning and amplification circuit 126 and power supply 124 via electrical lines 138 and electrical line 142, respectively.

When operating sensor 120 power supply 124 provides power to infrared source 126 such that infrared source 126 generates a beam of infrared electromagnetic radiation directed toward focusing optics 128. Focusing optics 128 directs the radiation through sample 132 positioned in contact with ATR crystal 130. As discussed above, certain wavelengths of the radiation are absorbed by organic substances contained within sample 132 as the radiation passes there through. The radiation exits the ATR crystal 130 positioned in contact with sample 132 and interacts with filter assembly 136. Filter assembly 136 restricts the infrared electromagnetic radiation allowed to substantially pass there through to the selected wavelength bands and the selected reference wavelength band. Each selected wavelength band and one or more selected reference wavelength bands interact with detection element 134 which generates an electrical signal in response to interacting with a wavelength band or the reference wavelength band. The electrical signal is communicated to mode-lock amplifier 140 via the aforementioned electrical lines.

Each electrical signal is then communicated to a processor (such as an integrated circuit; not shown) via an electrical line (not shown). The processor then processes the electrical signals with a mathematical model, such as a quantification algorithm, so as to provide a useful measurement of the amount of the organic substance of interest contained within sample 132. (Note that it is estimated that 10-20 reflections will provide adequate and measurable infrared absorption due to the organic substances in the biological sample.)

Turning now to FIG. 5D, there is shown a representative embodiment of a biological sampling and measurement apparatus 500 which can be utilized with the methods described herein. The biological sampling and measurement apparatus 500 has three main components: a fluids system 505, an infrared source, sensor and fluid cell assembly 510 and a housing assembly 503. The infrared source, sensor and fluid cell assembly 510 includes an emitter 515, a sampling cell assembly 517 and a detector assembly 519. The housing assembly 503 provides mechanical strength, structural support and an enclosure for the fluids system 505 and the infrared source, sensor and fluid cell assembly 510. A lid, sidewalls, and a front panel of the housing assembly 503 have been removed to show the internal components. As will be described in greater detail below, a biological fluid sample 555 may be, for example, taken from beneath the skin 553 of the patient and provided via piping 552 into the fluid cell assembly 510. The emitter 515, sampling cell assembly 517 and detector assembly 519 operate cooperatively in the quantification of a material of interest contained in the biological fluid sample 555. The emitter 515 emits radiation, which is absorbed by the biological fluid sample 555 housed in the sampling cell assembly 517. The detector 540 measures the intensity of radiation at certain discrete wavelengths. This spectral data is collected and processed according to the methods, algorithms and techniques described herein.

Housing Assembly and Electronics

The housing assembly 503 includes an outer plastic shell enclosing a chassis assembly 504 to which the other components of the biological sampling and measurement apparatus 500 are mounted. In a prototype used by the inventors, the housing assembly 503 is a plastic commercially available 6 piece enclosure such as the model 400XP86 series manufactured by Standard Injection Molding Company (SIMCO) of Avon Park, Fla. The enclosure includes a bottom, a top, two side walls, a front panel, and a rear panel. The top and bottom pieces screw together and fasten the other pieces together. Within the housing assembly 503 is a chassis assembly 504 that includes two mounting plates affixed at right angles to each other. The base portion of the chassis assembly 504 mounts to the bottom piece of the housing assembly 503. The chassis assembly 504 provides mechanical support for the various assemblies of the biological sampling and measurement apparatus 500 arranged within the housing assembly 503.

Two conventional circuit boards under control of an external computer are used to operate the biological sampling and measurement system 500. The circuit boards are a control circuit board and a detector circuit board. The control circuit board contains a suitable interface for communication with the external computer and an electrical connection for connecting the pump 511, the signal generator (for example, emitter 515), the detector 540, or a combination thereof to an external power source. The control circuit board includes an energy source capable of powering the pump 511, the signal generator (i.e., emitter 515), and the detector 540 as well as power to other the system components, as needed. The control circuit boars also controls the operation of the emitter 515 (e.g., modulation cycles and temperature); controls the settings of the selector valves 501, 502 and the operation of pump 511. The controller circuit board also collects data from the detector circuit board. The detector circuit board receives the signals output by the detectors 544, amplifies those signals and then converts them into digital signals. Additional functional details, operation and alternative configurations for the electronics used by the biological sampling and measurement apparatus 500 are possible and are similar to those described above with regard to FIGS. 2 through 5C.

In additional embodiments, the electronics system may be modified to also include a calculator. The calculator may be on the biological sampling and measurement apparatus 500 or reside in a separate computer connected to the biological sampling and measurement apparatus 500. The calculator may be useful for a variety of computational tasks related to utilizing or processing the post absorbance signal to aid in the treatment of a patient. The post-absorbance signal may be transmitted to the calculator where the calculator quantifies a biological substance of interest. Once this quantification data has been generated, the calculator may transmit the data to, for example, a display, a controller connected to a component adapted to treat or mitigate the presence of the biological substance of interest or store the data for later retrieval. Consider one particular example where the biological substance of interest is glucose. In this example, the calculator would be used to determine the glucose concentration data in the fluid. The component adapted to treat or mitigate the presence of the glucose could be, for example, an insulin infusion pump. Thus, in this example, the calculator is used to determine glucose concentration from the post-absorbance signal, and then (a) transmit the data to a display or (b) transmit the data to a controller of an insulin infusion pump, or (c) store the data for later retrieval. Alternatively, when the biological sampling and measurement apparatus 500 is used for the measurement of glucose, an insulin infusion pump may be operably integrated into the biological sampling and measurement apparatus 500. In operation, the insulin infusion pump would inject insulin into the patient under control of electronic circuitry that receives post-absorbance-signal information from the detector.

Fluids System

The fluids system 505 provides the motive force and fluid flow paths for the removal of a biological sample of interest from a patient and the movement of that sample through the fluid cell assembly 510 for measurement, quantification and evaluation. In the illustrated embodiment, the fluids system 505 includes a vacuum pump 511, two storage containers 507, 509 and various, standard medical grade flexible piping 552, fittings, and valves to connect the components and provide complete fluid flow paths as described below. A biological sample port connection 570 is provided in the top of the housing 503 and protrudes through the top cover. The biological sample port 570 may also be any suitable connection such as, for example, a stainless steel female Luer coupling. The piping 552 provides a conduit adapted to channel a cell-free, blood-based body fluid from a source location at or in a patient body to a measurement location, such as for example, the sample cell assembly 510, when the measurement location is outside a patient body. The piping 552 may be, for example, suitable medical grade piping used to connect the patient to the biological sample port 570; the biological sample port 570 to the sample/purge selector valve 501, as well as other fluid connections within the fluids system 505. The piping 552 may also be selected for compatibly with the pump flow rates described below.

The pump 511 includes, for example, a vacuum pump or other suction pump operably connected to the conduit and located distally to the measurement container. The pump pulls the fluid into the measurement container from the source location. The pump 511 may be any of a wide variety of miniature pumps capable of providing small volume pump rates. The pump 511 is operably connected to the conduit (i.e., piping 552) and provides motive force to fluid in the conduit. Examples include a pump rate from 0.008 to 7.3 ml/min. and preferably from 0.75 ml/min to 0.125 ml/min. A pump having this pump rate is commercially available. Even lower pump rates, available through other pumps would be satisfactory. A minimum pump rate will provide sample to be measured at time intervals of 30 minutes or less, preferably 20 minutes or less. The vacuum pump 511 is operated at a pumping rate that minimizes or eliminates bubble formation in the sample as it passes through the sample cell. In preferred embodiments, the vacuum pump 511 is operated at a pumping rate that ensures gases entrained in the biological sample remain in and are distributed throughout the sample. The vacuum pump 511 may be, for example, a miniature rotary peristaltic pump such as the Model P625/275.143 available from INSTECH Laboratories, Inc. of Plymouth Meeting, Pa.

In the illustrated examples, three fluids that can be pumped through the fluid cell assembly 510: air, water (dionized and/or distilled) and a biological sample 555. One exemplary fluid flow path will be described with regard to FIG. 5D. Another exemplary fluid flow path and piping configuration is illustrated in FIG. 5F. FIG. 5F illustrates how a flow path and piping configuration may be altered to maintain desired control of the fluid pathway but also reduce the length of the fluid pathway. A shorter fluid pathway is desired, especially when small volume samples are under evaluation. In that regard, the piping system and configuration may provide an even more direct conduit for a biological sample to travel from the sample location to the measurement location.

One exemplary fluid flow path for the illustrated biological sampling and measurement apparatus 500 of the invention will now be described with reference to FIG. 5D. The selector valves 501 and 502 are used to select between these fluids. The selector valves 501 and 502 are typically microfluid valves having zero dead volume. The selector valves 501 and 502 may be, for example, microfluid valves model LYFA1226032H available from Lee Company in Essex, Conn. Sample/purge selector valve 501 selects either the biological sample 555 via connection to the biological sample port 570 or a purge, for example, using water (deionized or distilled) from water reservoir 507. The output of the sample/purge selector valve 501 is connected to the air/water selector valve 502. The air/water selector valve 502 selects between filtered air via air filter 572 and the output of sample/purge selector valve 501. The output of the air/water selector valve 502 is connected to the pump 511. The pump 511 is plumbed using suitable tubing to the sample inlet port 528 of the fluid cell assembly 510. A fluid pathway exists from sample inlet port 528 through the sample port base plate 530, lower drilled hole 532, the space between windows 521, 522 and the spacer 523, the upper hole 532, the sample port base plate 530 to the sample outlet port 529. The sample outlet port 529 of the fluid cell assembly 510 is connected to the waste reservoir 509. When energized, the pump 511 will draw fluid from one of the three inputs through the fluid cell assembly 510 using the above fluid pathway and thence to the waste reservoir 509.

The waste reservoir 509 is provided with a pump port for removal of the reservoir contents. Alternatively, the waste reservoir 509 may be removed, emptied and replaced. The waste reservoir 509 provides a waste collection site for collecting the body fluid or biological sample 555 after the fluid has passed through the fluid cell assembly 510. The waste reservoir may receive the post measurement sample material thus allowing the sample cell to be purged and ready to receive a new sample. As such, the waste reservoir allows a further biological sample to be taken at a later time. In the case where the biological material of interest is glucose, an additional patient glucose sample may be taken and the new glucose level measured.

The biological sample 555 may be obtained and provided into the measurement container a number of methods. In one example, a conduit that includes a tube that is operably connected at one end to the measurement container and operably connected at its other end to a needle, a detachable needle connector, or a skin patch. In another example, a capillary filtrate collection membrane 550 is placed beneath the skin 553 into contact with the subcutaneous space of a patient using standard techniques such as those described above by Ash et al. In one embodiment the membrane 550 comprises a plurality of looped hollow fiber ultrafiltration membranes and forms one end of a microdiameter tube 552. The other end of the micro diameter tube is connected to the sample port 570. When placed under vacuum by pump 511, the fibers 550 create an ultrafiltrate which passes from surrounding capillaries, through the fibers 550 and into the micro diameter tubing 552. The biological sample 555 passes along tubing 552 into the biological sample inlet 570 and into the fluid cell assembly 510 via sample inlet port 528. As described from above, the biological sample 555 passes from the sample port 528 to the space between the optical windows 521, 522 where the biological sample 555 is exposed to radiation from emitter 515. Thereafter, the biological sample 555 exits through sample outlet port 529 and into waste reservoir 509. Alternatively, a waste collection site is provided for collecting the body fluid after the fluid has passed through the measurement container. The use of a waste collection site thereby allows a further patient glucose level to be determined at a later time. The waste collection site may be, for example, the waste reservoir 509.

In one embodiment of the present invention, the biological sample 555 obtained is a sample of a cell-free, blood-based body fluid. The body fluid may, for example, be a plasma, a serum, or an interstitial fluid. The biological sample 555 is transported from a source location at or inside a patient body to a measurement location outside a patient body. A measurement container is present at the measurement location. A measurement location may include having an embodiment of the biological sampling and testing apparatus 500 worn on the patient's person. The measurement container may be, for example, within an embodiment of the fluid cell assembly 510 such as the space created by windows 521, 522 and space 523. The source location, may be, for example, an implanted needle site, a subcutaneous membrane surface, or a skin surface subjected to ionoporation, microporation, or reverse iontophoresis.

One advantage of embodiments of the present invention involves measures taken to remove or diminish the diliterious influence of interfering materials that may be present in the biological sample. The interfering materials may adversely impact the accurate measurement and quantification of the biological material of interest within the sample. Several techniques and examples were set forth above. Optionally, a first filter may be operably connected to the conduit between the source location and the measurement location. If cells are present in the body fluid, the first filter removes cells from a blood-based body fluid obtained at the source location. Alternatively, either a first filter or a second filter operably connected to the conduit prior to the detection location has a molecular weight cut off in a range from 10 kD to 40 kD.

In one embodiment the biological sample 555 may be filtered using physical filtration prior to measurement in order to remove all or some potentially interfering materials or interferents. As will be described in more detail below, the wavelengths of radiation used for measurement may also be advantageously selected to remove or minimize the impact of interfering materials absorbance spectra on the accurate measurement and quantification of the absorbance spectra of the biological material of interest. In one embodiment of the present invention, the biological sample 555 is an interstitial fluid that is advantageously filtered to remove some, a portion of all of the interfering substances potentially present in the biological fluid before the interstitial fluid is provided to the fluid cell assembly 510. The filter is advantageously sized to allow the passage of the material of interest while blocking or filtering out potentially interfering materials from the sample.

One class of interfering materials suited to removal by physical filtration techniques are those having large atomic weights such as, for example, proteins. In one embodiment of the present invention, the biological sample 555 is an interstitial fluid that is filtered to remove proteins prior to passing an infrared signal through the interstitial fluid. Generally speaking, the amino acids present in proteins are the principal reason for their interfering absorbances (although prosthetic groups can also absorb light and cause interference). As used herein “protein” refers to any polypeptide, whether present as translated or as post-translationally modified, of any size. In practical terms, when proteins are being removed by filtration, the size of the proteins being removed is limited to being larger than the size of the molecule being measured. Specific examples are given later in this specification of size limits for the typical analyte glucose.

Since removing protein is intended to remove interfering absorbances, removal of all proteins larger than the substance being measured is desired. In one embodiment at least 80% of the proteins are removed prior to passing the infrared signal through the sample. In another embodiment at least 96% of the proteins are removed prior to passing the infrared signal through the sample. In another embodiment at least 98% of the proteins are removed prior to passing the infrared signal through the sample. Similar removal rates are preferred if the large interfering substance is a material other than a protein (such as DNA or a large carbohydrate). FIG. 5D provides an exemplary illustration of filtering a sample inside a subcutaneous location of a patient. It is to be appreciated that the biological sample 555 may be filtered outside patient body or at any of a variety of locations prior to passing an infrared signal through the sample.

In another alternative embodiment, the biological sample 555 is a body fluid that has been passed through a filter having a molecular weight cut off in a range from 10 kD to 100 kD prior to passing an infrared signal through the sample. In yet another alternative embodiment, the body fluid is passed through a filter having a molecular weight cut off in a range from 10 kD to 40 kD prior to passing an infrared signal through the sample. In yet another alternative embodiment, the body fluid is passed through a filter having a molecular weight cut off in a range from 10 kD to 25 kD prior to passing an infrared signal through the sample.

In another alternative embodiment, the biological sample 555 obtained is a biological fluid. In one embodiment, the biological fluid is a sample of capillary filtrate fluid that is transported from a subcutaneous location to a measurement location such as, for example, an embodiment of the fluid cell assembly 510. Additionally, the capillary filtrate fluid is filtered prior to passing an infrared signal through the sample. In another embodiment, the capillary filtrate fluid is passed through an ultrafiltration membrane at a subcutaneous location of the patient. In an alternative embodiment, the ultrafiltration membrane passes organics having less than 3000 molecular weight. In another alternative embodiment, the ultrafiltration membrane has a molecular weight cut off of 300 amu. In another embodiment, the ultrafiltration membrane is adapted to be placed at a subcutaneous location in a patient body. The membrane allows passage of capillary filtrate fluid via a catheter operably connected to the membrane to transport a capillary filtrate fluid from the subcutaneous location to a location outside said patient body. A vacuum operably connected to the catheter provides the motive force to the fluid in the catheter. More particularly, the membrane has a molecular weight cut off of 30 kD. Alternatively, the membrane passes drugs and organics of less than 3000 molecular weight.

Infrared Source, Sensor and Fluid Cell Assembly

Referring now to FIG. 5E, the infrared source, sensor and fluid cell assembly 510 includes a measurement container, a signal generator and a detector. The measurement container is used for receiving fluid at a measurement location. The measurement container is adapted to allow an infrared signal to pass through the fluid in the container over a measurement path of predetermined length. In one embodiment of the present invention where the measurement container is a sample cell, there is provided a method for determining the amount of a biological material of interest in a biological sample when the biological sample is present in the sample cell. The sample cell preferably has a defined path for passage of infrared radiation through the biological sample, such as a sample of capillary fluid filtrate. The sample cell is operably connected to a catheter or any other sampling device for receiving capillary filtrate from a subcutaneous location in a patient's body. In one particular embodiment the biological material of interest is glucose.

In another illustrative embodiment. there is provided a method for determining a patient glucose level by obtaining a sample of a cell-free, blood-based body fluid in a sample container, such as for example, a sample cell, where the sample container has a pre-defined measurement path. In this illustrative embodiment, the sample cell measurement path length is from 5 microns to 60 microns. In another illustrative embodiment, the sample cell path length is between 15 to 35 microns. In a specific example, the sample cell path length is 25 microns+/−5 microns. Additional details about the measurement container and the sample cell are provided below.

The infrared source, sensor and fluid cell assembly 510 also includes a signal generator. The signal generator is adapted to transmit an incident signal over the measurement path. In at least one embodiment, the incident signal is modulated and includes: wavelengths in a measurement range of from 7 to 11 microns; at least two glucose absorbance bands in the measurement range and at least one reference band. The detector is located to detect a post-absorbance signal. In at least one embodiment, the detector is configured to preferentially detect: a modulated signal relative to an unmodulated signal; at least two glucose absorbance bands in the measurement range and at least one reference band after the incident signal is absorbed by the sample.

The illustrated example of FIG. 5E will now be described. The emitter 515 generates and transmits an incident radiation signal that is absorbed by the biological sample 555 within the sample cell assembly 517. Thereafter, the detector 540 receives the radiation through spectral channels 544 and measures the intensity of radiation at discrete wavelengths. The incident radiation signal is advantageously selected to include one or more absorbance bands the material of interest that is to be characterized and quantified by the biological sampling and measurement apparatus 500. The exterior case of emitter 515 includes a feature that aligns the emitter 515 to the aperture 531. Fasteners, (not shown), are used to hold the emitter 515 in position against the sample port base plate 530 and in alignment with the aperture 531. Consider an exemplary embodiment where the material of interest is glucose. In this case, the incident radiation signal would be a mid infrared signal selected to include one or more of the glucose absorbance bands.

In another specific embodiment, the biological material of interest is glucose. As described above, the emitter 515 transmits mid infrared radiation through the biological sample containing glucose along a defined measurement path. More particularly, the incident signal is modulated and includes at least two glucose absorbance bands and at least one reference band. In one embodiment, the mid infrared radiation comprises wavelengths in a range of from 1200 cm⁻¹ to 900 cm⁻¹. In a particular embodiment, the two glucose absorbance bands are selected so that a first glucose absorbance band has a first absorbance ratio for an interfering substance potentially present in the biological fluid or sample and the second glucose absorbance band has a second absorbance ratio for the interfering substance. Alternatively, the transmitted mid infrared radiation also includes a third glucose absorbance band. In a specific embodiment the interfering substance is lactate.

The emitter 515 may advantageously be used to generate an incident infrared signal and transmit it along a measurement path within the fluid cell assembly 510. In one embodiment, the radiation generated by emitter 515 will pass through aperture 531 in the sample port base plate 530, the drilled window 521, the biological sample 555 contained in the space between windows 521, 522 and spacer 523, the plane window 522, the aperture 533 and into the spectral channels 544 of emitter 540. More specifically, the emitter 515 passes an incident infrared signal through a biological sample over a measurement path using an incident signal that includes wavelengths in a measurement range of from 7 to 11 microns. The incident signal also includes at least two absorbance bands in said measurement range for the biological material of interest and at least one reference band. In addition, the incident signal may be a modulated signal. In some embodiments, the modulated signal is modulated by varying current, voltage, or frequency of all or a portion of the incident signal.

In a specific embodiment, the biological material of interest is glucose. More particularly, the two absorbance bands are glucose absorbance bands. These first and second glucose absorbance bands are selected so that the first glucose absorbance band has a first relative absorbance for an interfering substance potentially present in a body fluid or biological sample. The second glucose absorbance band has a second relative absorbance for the interfering substance. More particularly, the first and second relative absorbencies are different from each other. In another embodiment, the incident signal further comprises a third glucose absorbance band selected so that the third glucose absorbance band has a third relative absorbance for an interfering substance potentially present in a body fluid or biological sample. Alternatively, the incident signal further includes a fourth relative absorbance for a second interfering substance potentially present in the body fluid or biological sample 555. In one embodiment, the interfering substance may be any one of or a combination of lactic acid, a lactate salt, ascorbic acid, an ascorbate salt, mannitol, acetaminophen, ethanol, or a phosphate salt. Alternatively, the interfering substance is lactic acid or a lactate salt and the second interfering substance is ascorbic acid, an ascorbate salt, mannitol, acetaminophen, ethanol, or a phosphate salt.

In another specific embodiment, the biological material of interest is glucose and the wavelength bands are selected according to the description above with regard to FIGS. 1, 1A, 1B, 1C, and 1D. The interference, baseline and reference wavelength bands are used to optimize glucose measurement accuracy of the selected glucose absorbance bands. In a specific embodiment, the two glucose bands are selected to be within or to overlap ranges selected from 1090 cm⁻¹ to 1075 cm⁻¹ [9.174 to 9.302 microns] and 1175 cm⁻¹ to 1137 cm⁻¹ [8.511 to 8.795 microns], and the baseline used is selected to be within or to overlap the range from 1180 cm⁻¹ to 1170 cm⁻¹ [8.475 to 8.547 microns]. In another specific embodiment, the wavelength bands are selected as follows: an interference wavelength band is selected to be within or to overlap ranges selected from a band having a center wavelength of 7.930 microns and a bandwidth of 170 nm [7.845 to 8.015 microns], a glucose band or bands if desired having a center wavelength of 9.320 microns and a bandwidth of 400 nm [9.120 to 9.520 microns], and a baseline band having a center wavelength of 8.330 microns and a bandwidth of 140 nm [8.260 to 8.400 microns]. In another specific embodiment, the two glucose bands are selected to be within or to overlap ranges selected from a glucose band having a center wavelength of 9.62 microns and a bandwidth of 200 nm [9.42 to 9.82 microns], another glucose band having a center wavelength of 9.32 microns and a bandwidth of 200 nm [9.12-9.52 microns], and a third glucose band having a center wavelength of 9.02 microns and a bandwidth of 200 nm. Other glucose, baseline, and interference wavelengths may also be used as discussed elsewhere, such as, for example, with regard to FIGS. 1 to 1D or as dictated by the individualized needs of a particular monitoring patient or as described in United States Patent Application Number US 2002/0016535 A1 entitled “Subcutaneous Glucose Measurement Device” by W. Blake Martin, et. al, the entirety of which is incorporated herein by reference.

In another embodiment a reference band is included. A reference band is an absorbance band from a reference material that is used to calibrate the apparatus. A typical reference band is obtained by measuring a stand substance, such as a precisely controlled solution or solid. The position of the band in cases of a separate measurement or in the case of double modulation (described below) can be at any location. However, if a controlled amount of a reference substance is added to the sample to create the reference absorbance, the reference band is selected to fall outside both the measurement band region and the interference band region (i.e., in a region where there is only baseline absorbance). Alternatively, the reference band may also be created by the addition of a substance that overwhelms any interfering signal. In different embodiments of the invention, the reference bands can be identical to the baseline wavelength bands by design or can be substantially different from the baseline wavelength bands. For example, reference wavelength bands of 1180 cm⁻¹ to 1170 cm⁻¹ [8.475 to 8.547 microns], 8.330 microns center wavelength and a bandwidth of 140 nm [8.260 to 8.400 microns], and 3.95 microns center wavelength and a bandwidth of 45 nm [3.905 to 3.995 microns] may also be used.

Emitter 515 may be any of a wide variety of commercially available infrared emitters capable of generating and transmitting radiation in the bandwidths of interest described above. The inventors have used the pulsIR® family of infrared emitters (model number NL8LNC) made by Ion Optics, Inc., of Waltham, Mass. These types of emitters are broadband infrared sources that generate signals in the 2-20 μm range. These emitters also feature a low thermal mass filament tailored for high emissivity. The emitter 515 may be operated in DC mode or, pulsed at rates from about 0.5 to about 10 Hz. As used by the inventors, the emitter 515 is driven by a flat topped current pulse of adjustable amplitude, length and frequency. It comes in standard sized TO5 and TO8 packaging typically rated at ˜850 deg C. and ˜2.25 Watts. Emitter 515 may or may not have a window. If a window is used, anti-reflective coated Germanium and Calcium Fluoride windows are suitable window materials in the range of interest. Constant current (P=I²R) or constant voltage (P=V²/R) drive schemes are the simplest and cost effective means of powering the emitter 515. The heating of the filament changes the resistance and hence the power output which is not desirable. Therefore a ballast resistor may be used to reduce the effect of source resistance on the power output of a constant current or constant voltage drive scheme.

Turning now to the sampling cell assembly 517, drilled window 521 has two holes 532 that align with sample ports 528, 529. Only the hole 532 that aligns with sample port 529 is illustrated in FIG. 5E. A spacer 523 separates drilled window 521 and plane window 522. The volume bounded by the interior faces of the windows 521, 522 in contact with the spacer 523 and the opening 534 of the spacer 523 is referred to as a sampling cell. The sampling cell is a space to store the biological sample 555 during testing and measurement. In this illustrative example, the spacer 523 is also used to set the path length for the sampling cell. For example, a spacer 523 that is 20 μm thick would result in a sample cell path length of 20 μm.

In some embodiments, the facing surfaces of the windows 521, 522 have a smooth surface. Depending upon the measurement pathwidth for a particular sample cell, the smoothness necessary for optimal operation varies. For larger cells, a smooth surface can refer to a surface roughness of less than 1 micron. As used herein surface roughness refers to the maximum difference between the highest and lowest points on the surface of a window. In some embodiments, the windows surface roughness is less than 0.5 microns. In yet another embodiment, the windows surface roughness is an optically smooth surface that is 0.1 micron. Because window roughness is a significant factor in small pathway sample cells (i.e., sample cells having a pathway of less than 60 microns), the roughness of the windows may be defined by the cell path ratio. The cell path ratio is the ratio of the window roughness (in microns) to the cell path length (in microns). In one embodiment, the cell path ratio is from about 0.2 to about 0.01. In yet another embodiment, the cell path ratio is about 0.04.

Returning to FIG. 5E, the windows 521, 522 are sealed using gaskets 525. One gasket 525 is in sealable relation between plane window 522 and sample cell holder 535. The sample cell holder 535 is threaded to receive end cap 516. Another gasket 525 is in sealable relation between the sample port base plate 530 and the drilled window 521. The sample port base plate 530 includes a sample inlet 528 and a sample outlet 529. The sample port base plate 530 also includes an aperture 531 that is sized and shaped to correspond to and receive the outer casing enclosing the emitter 515. An O-ring 527 seals the sample port base plate 530 to the end cap 516. The end cap 516 attaches to the sample cell holder 535 so as to apply pressure to seal together the above listed components (including spacer 523, if present), forming an assembly that is in turn attached to the mounting plate 526. The above components are also referred to as a measurement container that is operably connected to the conduit (i.e., piping 552 in FIG. 5D) for receiving fluid at a measurement location. This sample cell assembly or measurement container is adapted to allow an infrared signal to pass through the biological fluid sample at a detection location over a measurement path of predetermined length. The predetermined length of the present path may, in some embodiments, be set by the thickness of the spacer 523.

Several examples of sampling cells (e.g., the two windows 521, 522 and the spacer 523 between them) are available commercially in two basic configurations: sealed and demountable. The demountable configuration offers inherent flexibility in terms of choosing the window material and trying out an assortment of spacers with various path-lengths. The present inventors have found that the demountable cells are less prone to leakage than the sealed cells under the preferred operating described herein. The leak-proof aspect of the demountable cell design was further strengthened through use of an additional rubber gaskets 525. The gaskets 525 enabled the extremely tight window assembly necessary for a leak proof assembly but mitigated the risk of window breakage. The demountable sample cells also can be used with peristaltic pumps, without any leakage or damage to the sample cell, even with a sample cell path length as low as 25 μm. One commercial source of sample cells is Pike Technologies of Madison, Wis. Their cells are further described at

http://www.piketech.com/catalog/pdf_s/tliquid.pdf.

A relationship was found between the biological material being tested and the sample cell window material selected. The choice of the best infrared transmission window material for glucose measurement and quantification, for example, is dependent upon a number of factors including transmission range, water solubility, refractive index, available cleaning agents, sample reactivity, mechanical strength and thermal characteristics. This can be exemplified by design considerations for quantifying glucose in the mid infrared spectrum at wavelengths in a range of from about 8 to about 10 μm (i.e., about 1250 to about 1000 cm⁻¹ wave number region).

To test window materials, we began with the following window materials: barium fluoride (BaF₂), silicon (Si) and zinc selenide (ZnSe). These window materials are available commercially. For example, 32 mm diameter windows are commercially available having either 2 mm or 3 mm thickness. The table below lists some characteristics of the window materials in the relevant mid IR range:

| | % Transmittance | Refractive | |
|---|---|---|---|
| Material | (window thickness) | Index | Water solubility @250 C |
| BaF2 | 90 (3 mm) | 1.42 | 0.17 g/100 g H2O |
| Si | 55 (2.5 mm) | 3.4 | Insoluble. |
| ZnSe | 65 (1 mm) | 2.4 | Insoluble |

Initially, we believed that BaF₂ was the best choice because of its higher % transmittance, its refractive index being close to water, its non-hygroscopic nature, and its very low solubility in aqueous solutions. However, when barium fluoride windows were used, we observed a progressive reduction in the absolute signal level each time a glucose solution was added into the cell. Thus, as samples with increasing glucose were tested, the signals at the glucose wavelengths would decrease as expected, but if the process was reversed and samples with decreasing glucose concentrations were tested, the signals would not increase to their previous values. Effects of this type are commonly known as hysteresis. While not wishing to be bound by theory, we believe that the resulting signal hysteresis was most likely a result of the deposition of a whitish deposit or residue on the barium fluoride cell window material. This whitish deposit remained even after the windows were thoroughly cleaned using strong reagents like acetone, alcohol and the like. However, BaF2 is available with coatings, such as hydrophobic coatings, that would avoid the white residue. Such coated materials, however, were not tested because of the availability of other window materials.

Silicon was the next window material evaluated. Silicon is well known for its inert nature and well known fabrication techniques from the semiconductor industry as well as micro-electro mechanical system (MEMS) manufacturing and processing. While silicon was a good material choice from the mechanical and fabrication perspective, measurements with the readily available 2.5 mm thick silicon windows, however, did not provide measurable variations in signal with changes in glucose concentrations. However, unlike BaF₂, the Si windows had no whitish residue or deposit on their surface. While not wishing to be bound by theory, the lack of usable signal with silicon windows is thought to be due to the relatively low transmittance at the 2.5 mm thickness. Thinner silicon windows with appropriate surface roughness and surface treatment should be useable, but were not tested because of the availability of other materials.

As a result of these practical difficulties, zinc selenide (ZnSe) windows were investigated in two variations: coated and uncoated. When placed in our system, each of the uncoated windows presented and exposed a ZnSe surface to the biological sample. Another way of saying this is that the walls of the sample cell comprised ZnSe. Thus, one window (i.e., drilled window 521) exposed a ZnSe window surface to the emitter 515 and the other window (i.e., plane window 522) exposed a ZnSe window surface to the detector 540. Coated windows include those that have a commercially available antireflective coating (ARC) on, for example, one side of a window or both sides of the window. If on a single side, the coating can face the sample or the outside of the cell (i.e., the emitter or the detector). The commercially available ZnSe windows coated with an ARC material had a transmittance increase of about 25% when compared to the uncoated ZnSe windows.

We tested the ZnSe windows with and without ARC coating under operating conditions similar to those used to evaluate the other window materials. The zinc selenide windows were successful in obtaining useful readings. Additionally, no whitish deposit or residue was observed on the window surfaces exposed to the glucose samples even after multiple glucose sample introductions. As a result, use of ZnSe windows is considered to be advantageous for the measurement of glucoses, as its use meliorates the formation of residue and the resultant hysteresis effects described above with BaF₂ windows.

These results demonstrate that window material selection has an affect on the transmission of, for example, glucose absorption spectra associated with mid-IR transmission measurement techniques. However, suitable window materials can be prepared using standard design techniques as described here, including use of commercially available optical windows if the first selected material does not produce satisfactory results. It is likely that initial unsatisfactory results, even for an unsatisfactory window material as described here, can be overcome by standard design modifications, such as adding a protective coating or changing the thickness of the window.

Another design consideration for our system is the sample cell path length. The cell path length is distance through the sample that is traversed by the signal, such as the distance between the interior faces of the windows 521 and 522. The cell path length is determined by the thickness selection of the spacer 523, in this embodiment. The determination of the cell path-length is made, on the one hand, to get as high a transmittance signal as possible through the use of as low a cell path length as possible. On the other hand, if the cell path length is too small, then the sample 555 will not flow easily through the cell or will require an undue amount of time and effort to get the sample into and out of the sample cell space between the windows.

Another important design consideration for our system is the sample cell path length. In the embodiment shown, the cell path length is distance between the interior faces of the windows 521 and 522. The cell path length in this case is determined by the thickness selection of the spacer 523. The determination of the cell path-length is made, on the one hand, to get as high a transmittance signal as possible through the use of as short a cell path length as possible. On the other hand, if the cell path length is too small, then the sample 555 will not flow easily through the cell or will require an undue amount of time and effort to get the sample into and out of the sample cell space between the windows. In one particular embodiment, the cell pathlength is 25 μm that is maintained using a spacer 523 formed from Teflon with a 25 μm thickness. Other cell path lengths are possible, and the spacer 523 may be formed of other materials that are inert to the biological sample 555 and have sufficient strength to operate under vacuum. The spacer 523 has a circular shape in this embodiment that mirrors the shape of windows 521 and 522. The upper and lower portions of the diamond shaped opening 534 correspond to the drilled holes 532, sample outlet 529 and sample inlet 528. Opening 534 may have other shapes such as circular, elliptical, rectangular, or an irregular shape so long as the opening 534 allows fluid to pass from holes 532 and between the windows 521, 522. Opening 534 also has sufficient width that corresponds to the approximate size of or longer that the apertures 531 and 533.

Turning now to the detector assembly 519 (FIG. 5E), detector assembly 519 includes, for example, a pyroelectric detector 540 positioned within a detector shield 541 that is attached to the mounting plate 526. A plurality of spectral filtering channels 544 are arranged on the face of detector 540. Four channels are illustrated in FIG. 5E for purposes of illustration only. The number of filtering channels 544 will vary depending upon the number of bands utilized by the system. The detector 540 is controlled by detector printed circuit board 542 as described above. A plurality of standoffs 543 maintains the detector 540 in relation to the detector shield 541 and the mounting plate 526 as well as in relation to other components of fluid cell assembly 510.

Pyroelectric detectors obtain an output signal from changes in the electric polarization of a crystal, such as a LiTaO3 (lithium tantalate) crystal that changes as a result in changes in temperature. The temperature change is in turn caused by the changes in the incoming radiation levels generated by emitter 515. Ambient temperature variations and mechanical vibration have an adverse effect on pyroelectric detector performance. Standoffs 543 and detector shield 541 provide stability and help further isolate the detector 540 from air currents and ambient radiation. In addition, a thermally corrected detector may also be used to correct for ambient temperature variations.

We have demonstrated the apparatus and method using a commercially available multi-spectral detector, the model LIM314-X) manufactured by Infratec GmbH, Germany and distributed by Laser Components Inc., in the United States. The ‘X’ is the model number denotes the customized IR filters used with this detector. This particular detector has standard (i.e., serial) thermal compensation and is fitted with, in this illustrative example, four specific spectral channels. The specific spectral channels are hermetically sealed in one TO8 package and backfilled with dry nitrogen for stability and long term reliability. This detector operates in a voltage mode that provides a higher signal while using very low modulating frequencies. In one example, the modulated light input on the detectors is created by a systematic increase and decrease in the power supplied to the source at a frequency of 3 Hz. The infrared filters are available commercially from Laser Components of Santa Rosa, Calif. or directly from Northumbria Optical, UK. In one embodiment, representative filters and their characteristics are as follows:

| Center Wavelength (CWL) | Bandwidth (BW) |
|---|---|
| 7.930 microns | 0.170 microns |
| 9.320 microns | 0.400 microns |
| 8.330 microns | 0.140 microns |
| 3.95 microns | 0.09 microns |

In this illustrative example, the above filters are used as follows: the 7.930 micron center wavelength is used as an interference wavelength; the 9.320 micron center wavelength is a measurement wavelength for glucose; the 8.330 micron center wavelength is a baseline wavelength; and the 3.95 micron center wavelength is a reference wavelength. In general, these filters have a typical transmission of greater than 60-70%. Each filter will be sized according to the number of filters to be used as well as the overall size of the emitter 515 and detector 540 and the number of filters desired. In this particular exemplary embodiment, each filter is a square with length of 4.2 mm+0/−0.1 mm, width of 4.2 mm+0/−0.1 mm and a thickness of 1 mm±0.09 mm and covers one of the quadrants corresponding to one of four detector channels 544 in detector 540. While described as using four filters, it is to be appreciated that any combination of filters may be selected that provide measurement of the desired wavelengths.

It is important to note that the emitter 515, aperture 531, opening 534, aperture 533 and detector 540 have their axis of symmetry aligned. For all components except the detector and the filters the axis of symmetry is also the optical axis. The filters and detectors sample infrared radiation from the four symmetric quadrants around the geometric axis of symmetry. Since infrared radiation from multiple, in the illustrated example four, separate quadrants is sampled, it is advantageous for the sample in the fluid cell to have a homogenous composition in the four quadrants. In the embodiment shown in the figures, homogeneity is achieved through: (1) use of CFC device results in fluid sample with uniform consistency; (2) no precipitation or aggregation of sample in the fluid path; (3) gases in the sample remain in solution through use of slow pump speed. Other methods of achieving homogeneity include: symmetric injection and withdrawal of fluid from all four quadrants may be used. If sample uniformity can not be achieved then another way to achieve the desired results is the use of a diffuser or an optical fiber bundle between the cell and the detector to present infrared radiation leaving all four quadrants of the sample cell to all four detectors.

When assembled for operations as shown in FIG. 5D, the faces of the emitter 515 and detector 540 are spaced with an optimal distance. This distance needs to be minimized to minimize loss of signal by divergence of the beam, maintain alignment, and prevent signal loss by absorption by water vapor or any other absorbing vapors in the environment. In a specific embodiment a distance of 10 mm between the emitter 515 and the detector 540 faces has been achieved. In other embodiments the distance between the emitter and detector varies between 10 mm and 30 mm. Distances shorter than 10 mm are possible with further design modifications. In some embodiments, the spacing between the emitter 540 and the sample cell window 532 ranges from about 0.5 mm to about 5 mm. In a specific embodiment, the spacing between the emitter 540 and the sample cell window 532 is about 1 mm.

The detector assembly 519 includes advantageously selected detection capabilities that correspond to the various above mentioned incident radiation signals and post absorption signals generated as a result of passing the incident radiation through the biological sample 555. More specifically, the detector is used for detecting a post-absorbance signal comprising all of the absorbance bands after the incident signal is absorbed by the sample. In some embodiments of the present invention, the absorbance bands may include at least two glucose absorbance bands, at least one interference band, at least one baseline band and at least one reference band.

Alternatively, a portion of all of the incident radiation may be modulated and the detector configured to preferentially detect a modulated signal relative to an unmodulated signal. In one embodiment, the radiation generated by the emitter 515 is modulated. In one example of modulation, the intensity of the emitter output is varied over time. In a preferred embodiment, the emitter output is modulated to approximate sinusoid waveform. The use of a sinusoidal emitter signal allows the use of a digital lock in the amplifier circuit used in the detector electronics to isolate the sample specific signals from the background noise. In one embodiment of the present invention, the emitter output signal is modulated ad from about 0.1 Hz to about 10 Hz. In a preferred embodiment, the emitter output signal is modulated at about 3 Hz.

One method modulating the signal is to vary at least a part of the current, the voltage, or the frequency provided to the device that generates the incident infrared signal. This can also be done by blocking the signal using a mechanical chopper that has alternative windows formed from transparent and blocking (opaque) sections, with the infrared blocking material being inserted into the pathway of the incident signal. In yet another embodiment of the present invention, a second modulation technique is utilized. In this modulation technique, a radiation absorbing material is inserted into and removed from the optical pathway between the emitter 515 and the detector 540. The radiation absorbing material is selected so as to absorb in the wavelength(s) generated by the emitter 515. In an embodiment where the emitter generates a signal in the mid-infrared spectrum, the radiation absorbing material is selected to absorb mid-infrared radiation. In an embodiment of the present invention where the emitter generates a mid-infrared signal, the radiation absorbing material may be formed from polyethylene of a thickness of from about 0.05 mm to about 0.2 mm or more. Polyethylene is merely an illustrative example of a suitable radiation absorbing material. Another reference material can be one that absorbs one or more specifically selected wavelength bands including the baseline, interference, reference and glucose bands. Selection of such a material allows self calibration of the system gain as described in the following. It is to be appreciated that other reference materials may be used as the radiation absorbing material so long as it absorbs the radiation generated by the particular emitter being used.

The gain of the system can then be determined using signals obtained from a known good sensor/system in a controlled environment (i.e., the gold standard or known good readings obtained in manufacturing) as compared to the signals obtained from a system in operation with a particular user. Any of several signal calibration algorithms may be used and executed by the system. One representative signal calibration algorithm is:

Sc=Signal obtained from the system for a given sample.

Scm=Signal from the system for a given sample, when the second modulation material is inserted into the light path.

Sg=Signal that would have been obtained for the sample if the sample had been measured on the gold standard meter, in manufacturing.

Sgm=Signal that would have been obtained for the sample if the sample had been measured on the gold standard meter, in manufacturing, with the second modulation material in the light path.

Sgm=Sg−Sm where Sm is the amount of signal due to the light absorbed by the second modulation material. Sm is measured in the factory on the gold standard meter.

Scm=Sc−a*Sm where a is the gain of the instrument being calibrated.

The gain a=(Sc−Scm)/Sm

This a second modulation technique is particularly useful in determining the overall operational status of the biological sampling and measurement apparatus 500. Regular readings from the second modulation technique may also be utilized to determine the presence and magnitude of the gain shifts in the emitter/sample cell/detector system whenever such gain shifts occur. The ability to detect and compensate for shifts in instrument readings is especially important when the biological sampling and measurement apparatus 500 is used for continuous glucose monitoring. The use of the second modulated technique allows the system to inform the user that a particular sample may have, for example, an erroneous reading or that some system component has failed or is not performing according to specifications. In one embodiment of the present invention, the radiation absorbing material is placed in the optical pathway of the system once about every 12 seconds. In another alternative embodiment, the radiation absorbing material is placed in the optical pathway about once every second. In yet another embodiment, the radiation absorbing material is placed in the optical pathway at any time interval sufficient to provide a useful reference measurement. The radiation absorbing material can be reinserted as needed to provide results of the desired accuracy. The radiation absorbing material needs to stay in place for a time sufficient for a measurement to be made. In one embodiment, measurements can be made in a time span of 0.3 second. Longer or shorter second modulation times can be used for other apparatuses, depending on their operating characteristics. It is to be appreciated that in embodiments of the present invention the emitter modulation and the second modulation technique can be used in conjunction to provide a double modulation mode for the emitter/detector system. Any of the emitter modulations may be used with any of the second modulations.

An alternative is to combine the blocking (chopping) technique with a second modulation technique. In this alternative, the chopper (often a wheel rotated by a motor) has three (or more) types of sections: a transparent section, a fully blocking section, and a reference section. For example, the chopper could contain holes (the transparent section), opaque material (the blocking section), and polyethylene film (the reference section). However, it is also possible to use two different modulation techniques. For example, the first modulated signal can be the emitter output modulated at from 0.1 Hz to 10 Hz and the second modulation technique can be placing and removing a radiation absorbing reference material in the pathway of the infrared signal at a different rate.

The following example illustrates utilizing one wavelength band and one reference wavelength band for providing a measurement of the amount of glucose contained within LRS without changes in the concentrations of any other components such as lactate. In particular, eight known concentrations of glucose dissolved in identical batches of LRS without altering any other chemical component were prepared, i.e., 0%, 0.05%, 0.075%, 0.1%, 0.2%, 0.3% 0.4%, and 0.5% glucose. The selected absorption band for this example is in the range of wavenumbers from about 1075 cm⁻¹ to about 1090 cm⁻¹ (see FIG. 1). The selected reference wavelength band for this example is the range of wavenumbers from about 1090 cm⁻¹ to about 1095 cm⁻¹ (see FIG. 1). Each glucose solution was illuminated with incoherent electromagnetic radiation and the absorbance corresponding to the selected wavelength band and the selected reference wavelength band was measured. In addition, the absorption band corresponding to the wavelength band, i.e., the wavenumbers from about 1075 cm⁻¹ to about 1090 cm⁻¹ for each glucose concentration was integrated. Furthermore, the absorption band corresponding to the reference wavelength band, i.e., the wavenumbers from about 1090 cm⁻¹ to about 1095 cm⁻¹ for each glucose concentration was also integrated. Note that the integrated absorbances were divided by their corresponding band widths to avoid scaling effects. Thereafter, a mean-centered integrated absorbance band ratio for the wavelength band and the reference wavelength band was calculated for each glucose concentration. In particular, the absorbance band ratio was calculated by dividing the mean-centered integration value for the absorbance of the selected wavelength band by the mean-centered integration value for the absorbance of the selected reference wavelength band. Accordingly, each of the above described glucose concentrations has a mean-centered integrated absorbance ratio associated with it as shown in Table 1 below.

TABLE 1

| Glucose Concentration | Integrated Absorbance Ratio |
|---|---|
| 0% | 0.896246 |
| 0.05% | 0.896550 |
| 0.075% | 897490 |
| 0.1% | 0.897669 |
| 0.2% | 0.899011 |
| 0.3% | 0.901061 |
| 0.4% | 0.902709 |
| 0.5% | 0.905265 |

*The above values are not mean-centered. Mean-centering is done by the Matlab code discussed below.

The above mean-centered values of the glucose concentrations and the integrated absorbance ratios were used to generate a regression model and to obtain calibration constants. The concentration of glucose in solution was calibrated using the following equation 1:

C_{g}=P_{O}+P₁IAR²_{λ,1}+P₂IAR²_{λ,1} (equ. 1)

where (i) C_{g} is the mean-centered concentration of glucose in the sample measured using methods other than IR absorption, (ii) Pᵢ are calibration constants, and (iii) IAR_{λ,1} is a mean-centered integrated absorbance ratio for the selected wavelength band and selected reference wavelength band. As previously mentioned, in this equation the variables are mean-centered. The values of the calibration constants are calculated by Matlab 6.1.0.450 release 12.1, the MathWorks Inc. utilizing the following code:

clc;

pwd

fid1=fopen(‘MLR-glucose. Tst’);

n=7

[C,count−C]=fscanf(fid1,‘% g’,[1,n]);

[A,count_A]=fscan(fid1,‘% g’,[n,2]);

A

C=C′

mA−mean(a)

mC=mean(C)

B=A(1,1)−mA(:,1)

B1=A(:,2)−mA(:,2)

mcC=C−mC

mcA−cat(2,B,B 1)

Regstats(mcC,mcA,‘quadratic’)

This code mean centers the concentration and absorbance and does a multiple linear regression on the given absorbance matrix and concentration vector (quadratic uses constant, linear, cross product and square terms). Note that the values of the calibration constants are used in the validation. Further note that validation of the calibration constants is done by reworking the calibration after deleting 1 point. The resulting fit is used to predict the deleted point. The results of the computations utilizing the Matlab program to process the aforementioned data are shown below in Table 2.

TABLE 2

| Actual % Glucose | Calibration % | Validation % |
|---|---|---|
| 0 | 0.0074 | 0.0019 |
| 0.05 | 0.0287 | 0.0388 |
| 0.075 | 0.0928 | 0.0888 |
| 0.1 | 0.1046 | 0.1036 |
| 0.2 | 0.1897 | 0.1935 |
| 0.3 | 0.3075 | 0.3029 |
| 0.4 | 0.3915 | 0.3958 |
| 0.5 | 0.5028 | 0.4770 |

*Validation is done by delete-1-calibration.

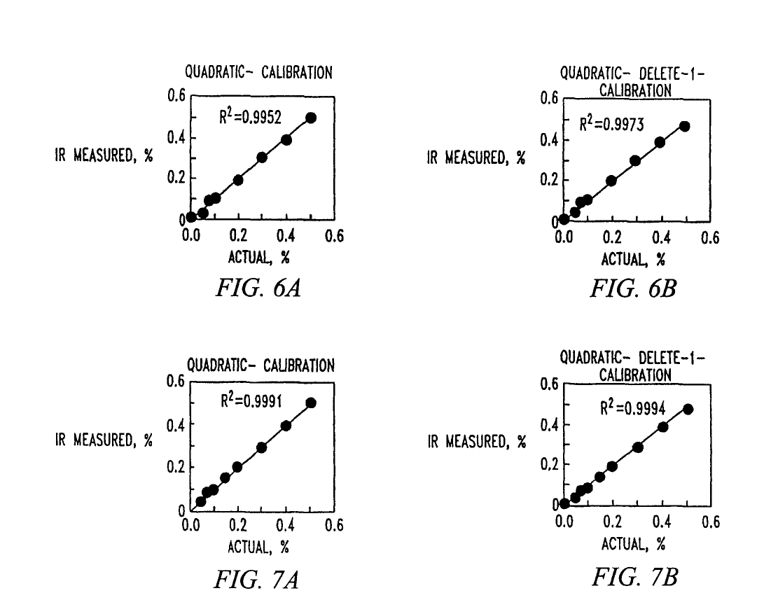

Both linear (using only the first two terms in the above equation) and quadratic (using all the terms in the above equation) regression fits were considered. The quadratic fit of the integrated absorbance bands gave the best results for the LRS glucose solutions using this model. The resultant fits of the actual and measured glucose concentrations are shown in FIGS. 6A and 6B. Accordingly, it should be appreciated that a sensor, such as one of the sensors described herein, can utilize calibration constants obtained in the above described manner and give a useful measurement of the glucose concentration in a biological sample based upon the absorbance signal from the Wavelength band and the reference wavelength band.

The above described procedure was repeated in a substantially identical manner with the exception that aqueous glucose solutions were prepared rather than LRS glucose solutions. Both linear and quadratic regression fits were considered for the aqueous glucose solutions. The quadratic fit of the integrated absorbance bands gave the best results for the aqueous glucose solutions using the above described model. The resultant fits of the actual and measured aqueous glucose concentrations are shown in FIGS. 7A and 7B.

The following is another example which illustrates utilizing a method described herein to provide a measurement of the amount of glucose contained within an LRS solution. However, in this method the absorbance from two wavelength bands and one reference wavelength band are utilized for providing a measurement of the amount of glucose contained within the LRS solution. The method is similar to that described above for utilizing one wavelength band and one reference wavelength band. In particular, eight known concentrations of glucose dissolved in LRS were prepared, i.e., 0%, 0.05%, 0.075%, 0.1%, 0.2%, 0.3% 0.4%, and 0.5% glucose. The selected wavelength bands for this example are the range of wavenumbers from about 1075 cm⁻¹ to about 1090 cm⁻¹ (see FIG. 1) and the range of wavenumbers from about 1137 cm⁻¹ to about 1175 cm⁻¹. The selected reference wavelength band for this example is the range of wavenumbers from about 1170 cm⁻¹ to about 1180 cm⁻¹ (see FIG. 1). As described above, each glucose solution was illuminated with incoherent electromagnetic radiation and the absorption bands corresponding to the selected wavelength bands and the selected reference wavelength band was measured. In addition, the absorption band corresponding to the wavelength bands, i.e., the wavenumbers from about 1075 cm⁻¹ to about 1090 cm″ and the wavenumbers from about 1137 cm⁻¹ to about 1175 cm⁻¹, for each glucose concentration was integrated. Furthermore, the absorption band corresponding to the reference wavelength band, i.e., the wavenumbers from about 1170 cm⁻¹ to about 1180 cm⁻¹ for each glucose concentration was also integrated. Note that, as before, the integrated absorbances were divided by their corresponding band widths to avoid scaling effects. Thereafter, a mean-centered integrated absorbance band ratio for each of the wavelength bands and the reference wavelength band was calculated for each glucose concentration. In particular, as before, the absorbance band ratio was calculated by dividing the mean-centered integration value for the absorbance of each of the selected wavelength bands by the mean-centered integration value for the absorbance of the selected reference wavelength band. Accordingly, each of the above described glucose concentrations has a mean-centered integrated absorbance ratio associated with it as shown in Table 3 below.

TABLE 3

| | Integrated Absorbance | Integrated Absorbance |
|---|---|---|
| | Ratio for | Ratio for |
| | 1075 cm⁻¹-1090 cm⁻¹ | 1137 cm⁻¹-1175 cm⁻¹ |
| Glucose Concentration | wavenumber band | wavenumber band |
| 0% | 0.926683 | 0.879391 |
| 0.05% | 0.927934 | 0.879949 |
| 0.075% | 0.927893 | 0.880182 |
| 0.1% | 0.929363 | 0.880122 |
| 0.2% | 0.931147 | 0.880795 |
| 0.3% | 0.936557 | 0.881594 |
| 0.4% | 0.943733 | 0.882822 |
| 0.5% | 0.946844 | 0.883629 |

The above values are not mean-centered. Mean-centering is done by the Matlab code discussed below.

As before, the above mean-centered values of the glucose concentrations and the integrated absorbance ratios were used to generate a regression model and to obtain calibration constants. The concentration of glucose in solution was calibrated utilizing the following equation 2:

C_{g}=P₀+P₁IAR_{λ,1}+P2IAR_{λ,2}+P₄IAR²_{λ,1},+P₄IAR²_{λ,2}2+P₅IAR_{λ,1},IAR_{λ,2} (equ. 2)

where (i) Cg is the mean-centered concentration of glucose in the sample measured using methods other than IR absorption, (ii) P₁ are calibration constants, and (iii) IAR_{λ,j} is a mean-centered integrated absorbance ratio of two of the selected infrared wavelength bands and the selected reference wavelength band. As previously mentioned, in this equation the variables are mean-centered. The values of the calibration constants are calculated by Matlab as discussed above utilizing the following code:

Clc;

Pwd

Fid 1=fopen('MLR-glucose.txt);

N=7

[C,count_C]=fscan(fid1,‘% g’,[1,n]);

[A,coun_A]=fscanf(fid1,‘% g’, [n,3]);

A

C=C′

mA=mean(A)

mC=mean(C)

B=A(:,1)−mA(:,1)

B1=A(:,2)−mA9(:,2)

B2=A(:,3)−mA(:,3)

mcC=C−mC

mcA=cat(2,B,B1,B2)

regst ats(mcC,mcA,‘quadratic’)

As before, this code mean centers the concentration and absorbance and does a multiple linear regression on the given absorbance matrix and concentration vector (quadratic uses constant, linear, crossproduct and square terms). Note that the values of the calibration constants are used in the validation. Further note that validation of the calibration constants is done by reworking the calibration after deleting 1 point. The resulting fit is used to predict the deleted point. The results of the utilizing the Matlab program to process the aforementioned data are shown below in Table 4.

TABLE 4

| Actual % Glucose | Calibration % | Validation % |
|---|---|---|
| 0 | 0.0016 | −0.0683 |
| 0.05 | 0.0526 | 0.048 |
| 0.075 | 0.0782 | 0.0705 |
| 0.1 | 0.093 | 0.0974 |
| 0.2 | 0.1953 | 0.2031 |
| 0.3 | 0.3075 | 0.2923 |
| 0.4 | 0.399 | 0.4327 |
| 0.5 | 0.4997 | 0.5492 |

* Validation is done by delete-1-calibration.

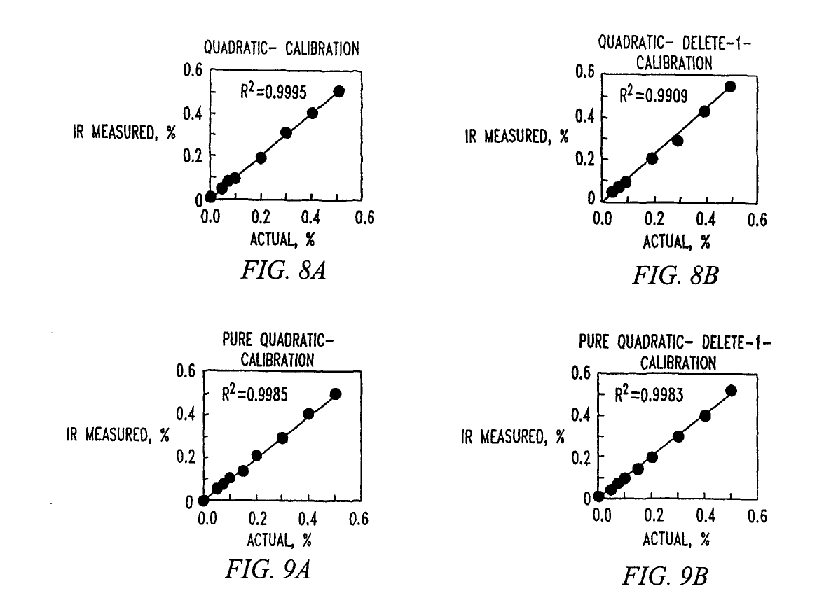

Linear, interaction, quadratic, and pure quadratic regression fits were considered. Linear regression involved only the first three terms in the above equation. Interaction involved the linear terms and the fifth (interaction) term. Quadratic regression involved all the terms in the above equation. Pure quadratic regression involved all the terms except the interaction term. The pure quadratic calibration model for the LRS glucose solutions gave the best results. The resultant fits of the actual and measured glucose concentrations are shown in FIGS. 8A and 8B. Therefore, it should be appreciated that a sensor, such as one of the sensors described herein, can utilize calibration constants obtained in the above described manner and give a useful measurement of the glucose concentration in a biological sample based upon the absorbance signal from two wavelength bands and a single reference wavelength band.

The above described two wavelength band procedure was repeated in a substantially identical manner with the exception that aqueous glucose solutions were prepared rather than LRS glucose solutions. The quadratic fit of the integrated absorbance bands gave the best results for the aqueous glucose solutions using the above described model. The resultant fits of the actual and measured aqueous glucose concentrations are shown in FIGS. 9A and 9B.

It should be appreciated that the presence of lactate in the glucose LRS solutions presents a challenge to the methods described herein since lactate and glucose have absorption bands in the same mid infrared region. However, as demonstrated above, useful correlations can be obtained through the proper selection of wavelength bands, reference wavelength band, and calibration method which can be identified via routine experimentation.

It should be appreciated that while the above examples utilize equations 1 and 2 to calibrate the glucose in the sample solution other equations can be utilized. For example, the following equations 3 and 4 can be utilized:

C_{g}=Pₒ+P₁A_{λ,1},+P₂IA_{λ,2},+P₃IA²_{λ,1}+P₄IA²_{λ,1}+P₅IA²_{λ,2} (equ. 3)

where (i) C_{g} is the mean centered concentration of glucose in solution measured using methods other than IR absorption, (ii) Pᵢ are calibration constants, and (iii) IA_{λ,1 and IA}_{λ,1} are the mean centered integrated absorbance for the selected wavelength band and the selected reference wavelength band,

C_{g}=P₀+P₁IA_{λ,1}+P₂IA²_{λ,2},+P₃IA²_{λ,3}+P₄IA²_{λ,1},+P₅IA²_{λ,2}+P₆Ia²_{λ,1}+P₇IA_{λ,1}IA_{λ,2}+P₈IA_{λ,1},IA_{λ,3}P₉IA_{λ,1}IA_{λ,3} (equ. 4)

where (i) C_{g} is the mean centered concentration of glucose in solution measured using methods other than IR absorption, (ii) Pᵢ are calibration constants, and (iii) IA_{λ1} is the mean centered integrated absorbance for band j.

It should be appreciated that equations 3 and 4 use integrated absorbance rather than integrated absorbance ratios as shown in equations 1 and 2 above, i.e., the reference band is used as additional absorbance terms instead of being used in the denominator term in equations 3 and 4.

The following discussion is directed to obtaining useful measurements of the amount of glucose contained within water, LRS, and CFC fluid (i.e., capillary filtrate collector fluid) utilizing ATR (i.e., Attenuated Total Reflectance) measurements in the mid infrared (about 1200 cm⁻¹ to about 900 cm⁻¹)⁻ region.

The measurements were made using a Nicolet Nexus7 670 spectrometer equipped for mid infrared measurements with a liquid nitrogen-cooled MCT-A detector and an XT-ISf3r beamsplitter. Multi-bounce ATR measurements were made by taking the background measurements before each sample measurement. The resolution was set at 4 cm⁻¹ and 64 scans were collected and averaged. Using a sealed and desiccated system minimized the atmospheric water vapor and carbon dioxide absorption effects. Further, sufficient period of time was allowed between the mounting of the sample and the actual measurement in order to let the system reach equilibrium.

The aqueous glucose solutions and the LRS solutions were made by dissolving appropriate quantities of d-glucose in distilled water and LRS. The solutions were prepared in large quantities for the lower concentrations and in small quantities for the higher concentrations with a view to maintaining the uncertainties due to weight measurement constant. Concentrations of glucose in these solutions varied in the range of 0.05%-0.5% or 50-500 mg/dL.

Another fluid obtained for the analysis was from a CFC implanted in a rat's blood stream. The fluid collected was taken and analyzed the same day with minimum refrigeration in between. The amount of fluid obtained in this manner was 1-2 mL. Therefore, a plexiglass insert was designed and used to compress the fluid down to the required volume. This design was useful in wetting the ATR crystal surface without loss of significant amount of fluid. The plexiglass material is transparent. Therefore, it helped ensure that the crystal was completely wetted via visible inspection. The fluid volume was reduced to 40 pL through this modification.

A total of 52 samples of CFC fluid were obtained in this manner from the same rat on different days. Of these, 9 were rejected due to suspicion of contamination at the implantation site or due to undetectably (using an Accu-chekB meter) low glucose values, 18 samples were from the rat when it remained healthy and 25 were obtained after the rat turned diabetic. After about a month, diabetes was induced in the rat by injection of Streptozotocin. This resulted in the glucose levels reaching higher values than normal and gave a number of calibration points beyond the normal range of 75-150 mg/dL. Values as high as 870 mg/dL were obtained. These values of glucose concentration were measured using an Accu-chekB glucose meter and test strip. Blood glucose levels were monitored as well but since the CFC fluid sample is collected over a period of time, comparisons could not be made between the blood glucose levels and the CFC glucose levels in the present discussion. However, it is known that CFC glucose levels correlate well with blood glucose levels after accounting for the time lag associated with the transport of the CFC fluid from the CFC to the sampling port.

The quantification methods utilized were Inverse Multiple Linear Regression (IMLR) of absorbance bands which correspond to (i) one wavelength band and one reference wavelength band and (ii) two wavelength bands and one reference wavelength band, with linear, interaction and quadratic terms and Partial Least Squares (PLS) considered. In the case of IMLR, as discussed above, mean-centered absorbance values from the selected wavelength band(s) and selected reference wavelength band were used along with the above described ratio of wavelength band(s) absorbance values/reference wavelength band absorbance values.

2 Wavelength Band IMLR

In this method, as previously discussed, the integrated absorbance in one wavelength band (e.g., 9.17 μm-9.3 μm; 1090 cm⁻¹-1075 cm⁻¹) and one reference wavelength band (e.g., 9.13 μm-9.17 μm; 1095 cm⁻¹-1090 cm⁻¹) were calculated from the measured spectra of the solutions at different concentrations. As discussed above, the reference wavelength band is used as a reference baseline band and is used to ratio out the reference signal variations. Further, the integrated absorbances are divided by the bandwidth to avoid scaling effects. Mean-centered values of the concentrations and integrated absorbance ratios are used to generate a regression model and to obtain the calibration constants. The concentration of glucose in solution was calibrated by using the above discussed equation 1. Both linear (using only the first two terms in equ. 1) and quadratic (using all the terms in equ. 1) regression fits were considered.

3 Wavelength Band IMLR

This method is similar to the above method except that two wavelength bands and one reference wavelength band were considered as illustrated as an example in Table 1 below. It is noted that the choice of wavelengths utilized in the methods described herein are specific to the type of sample fluid being assayed. For example, the wavelength bands set forth in Table 1 below were selected for glucose in LRS utilizing the criteria described herein (e.g., ensuring that the absorption band contained within the wavelength band is an absorption band of the organic substance of interest, selecting a wavelength band which has relatively strong absorption, and selecting a wavelength band in which absorption is relatively free of interference, or separated from, adjacent absorption bands). On the other hand, the wavelength bands set forth in Table 2 below were selected for glucose in rat CFC utilizing the criteria described herein. As shown in Table 2, the wavelength bands selected for glucose in rat CFC are different from those selected from glucose in LRS.

Similar to the above described method, i.e., the 2 wavelength band IMLR, mean-centered values of the concentrations and integrated absorbances are used to generate a regression model and to obtain the calibration constants. The concentration of glucose in solution was calibrated using the above discussed equ. 2. Linear, interaction, quadratic and pure quadratic regression methods were considered. Linear regression involved only the first three terms in equ. 2. Interaction involved the linear terms and the fifth (interaction) term. Quadratic regression involved all the terms in equ. 2 and pure quadratic regression involved all the terms except the interaction term.

Multivariate Calibration Using PLS

Partial Least Squares (PLS) is a multispectral calibration method that uses the absorbance data at many different wavelengths. PLS uses the concentration and absorbance information and represents them in terms of “latent” variables. These latent variables are fitted with a regression equation using a least squares technique. The number of variables is reduced using a principal component analysis (PCA) step. More details of the method can be found in Geladi P. et al. Partial Least-Squares Regression: A Tutorial, Analytica Chimica Acta 1986 1-17, which is incorporated herein by reference.

For the aqueous and LRS glucose solutions, PLS was used in the regions of glucose absorption and no baseline correction was used. In the case of the CFC fluid, a sensitive fit was used and a non-linear fit was used. The best correlations were obtained for a quadratic baseline fit-corrected PLS with a non-linear fit.

It should be appreciated that the above discussed methods are inverse calibration methods. These methods are expected to be more successful in the presence of interferences in signals (absorption) from other components since they do not involve a dependence on the concentrations of the “unimportant” components in the fluid.

Aqueous Glucose Solutions

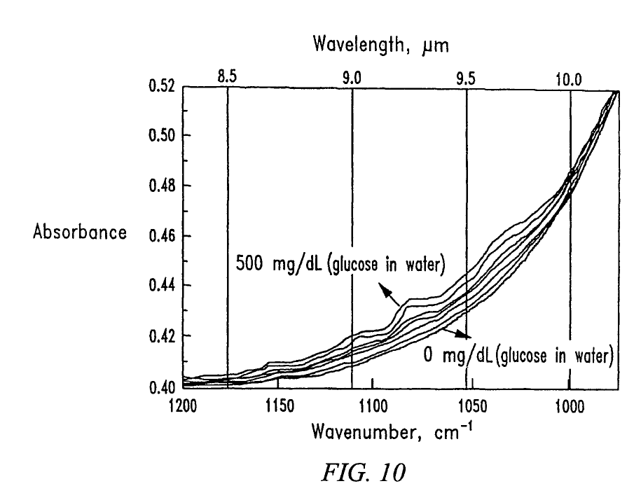

The ATR spectra of aqueous glucose solutions in the spectral range of about 1200 cm⁻¹ to about 975 cm⁻¹ (8.3-10.3 μm) are shown in FIG. 10. The major absorption peaks due to glucose are identifiable along with the less prominent ones.

One wavelength band and one reference wavelength band in this region correlate well with glucose concentrations and were selected for the calibration. With respect to the selected reference wavelength band, it was chosen based on its moderately invariant effect with respect to glucose concentration. These selections were based on the best results for the LRS glucose solution spectra discussed below.

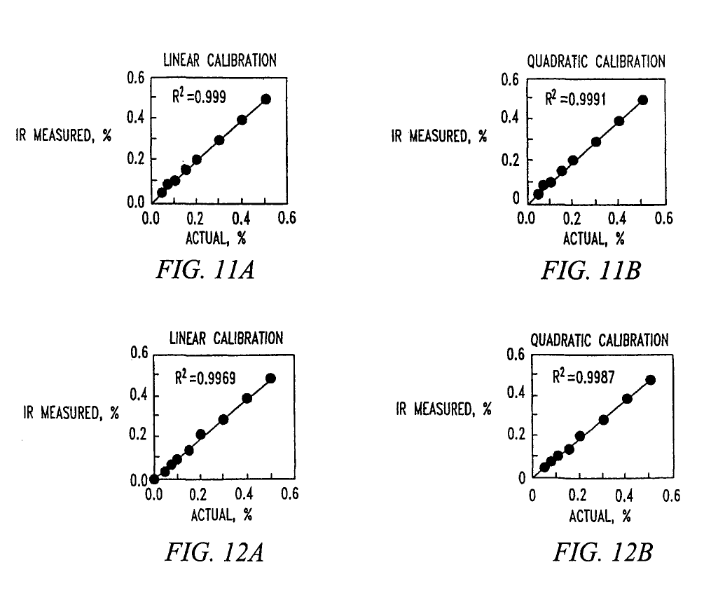

The best results for aqueous glucose solutions using the IMLR model discussed above were obtained for quadratic fits. It is well known that Beer's law models are usually linear as the absorbance is expected to vary linearly. However, it is seen in the present case that the quadratic fits are better probably because the interaction effects are appreciable. FIGS. 11A and 11B show the results of the one wavelength band and one reference wavelength band IMLR with linear and quadratic fits respectively. Both the fits show good performance with a correlation coefficient of 0.999 as is to be expected in the absence of interferences. There is a marginal improvement in the correlation with a quadratic fit.

FIGS. 12A and 12B show the results of the two wavelength band and one reference wavelength band IMLR. The correlation is improved for a quadratic fit. However, it is seen that this fit shows slightly poorer correlation compared to the one wavelength band fit. This may be due to the fact that the reference wavelength band was selected with the LRS interferences to glucose in mind and therefore, the performance worsened in the case of the aqueous glucose solution.

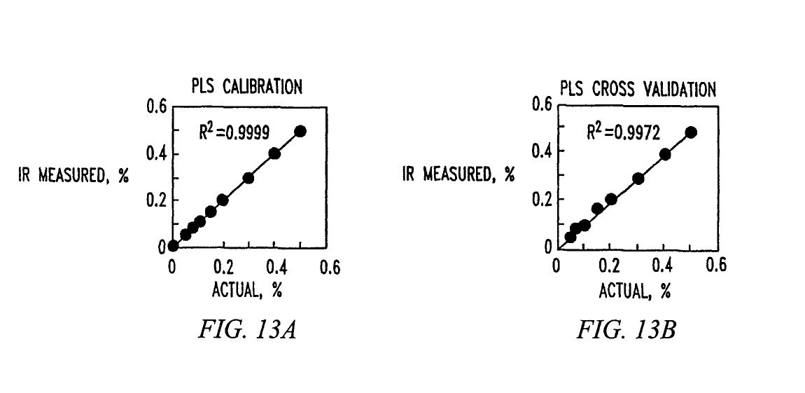

FIGS. 13A and 13B, show the results of the Partial Least Squares calibration (PLS) in the about 1190 cm⁻¹ to about 980 cm⁻¹ (8.4-10.2 μm) wavenumber range. Since this region contains the glucose absorbance information the correlations are expected to be high. FIG. 13A shows a high correlation coefficient of 0.9999 for the calibration. FIG. 13B shows the results of leave-1-out cross validation, the correlation coefficient being 0.997. These values are close to those obtained in the case of the IMLR methods indicating that most of the glucose absorbance information is contained within the bands chosen for the IMLR analysis.

LRS Glucose Solutions

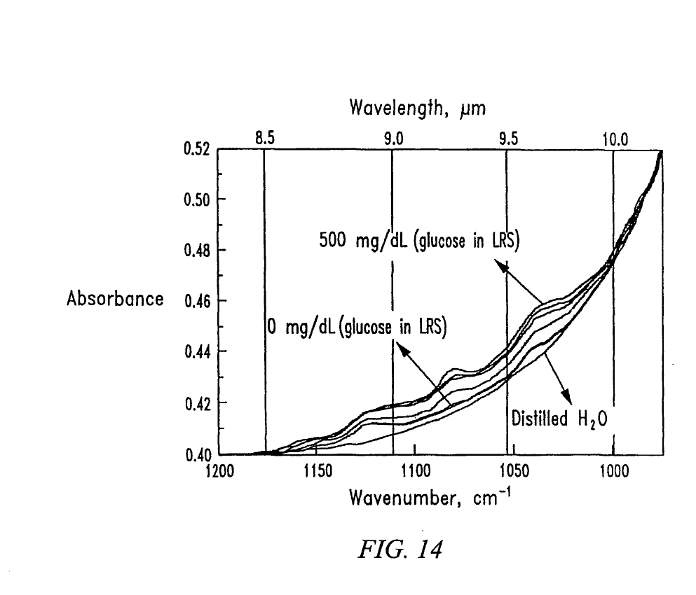

LRS was spiked with glucose in the 0.05-0.5% concentration range and the spectra of these solutions in the spectral range of about 1200 cm⁻¹ to about 975 cm″ (8.3-10.3 μm) are shown in FIG. 14. The ions (sodium, potassium, calcium and chloride) present in the solution cause a large shift in baseline. These shifts have been accounted for through a baseline correction procedure in FIG. 14. The glucose absorption and the peaks due to lactate are seen. The glucose peaks appear shifted and distorted compared to the ones in the case of aqueous glucose solutions. This is due to the effect of the peaks due to the lactate which are present in the same region as the glucose. The challenge for the IMLR algorithm is therefore, to select the correct wavelengths that correlate with the glucose concentration while accounting for the interfering effects of the lactate. However, it may be argued that there are systematic effects due to the fact that the concentration of the lactate is expected to correlate with the concentration of glucose. This argument will be settled by the results obtained for the case of CFC fluid presented in the next section.

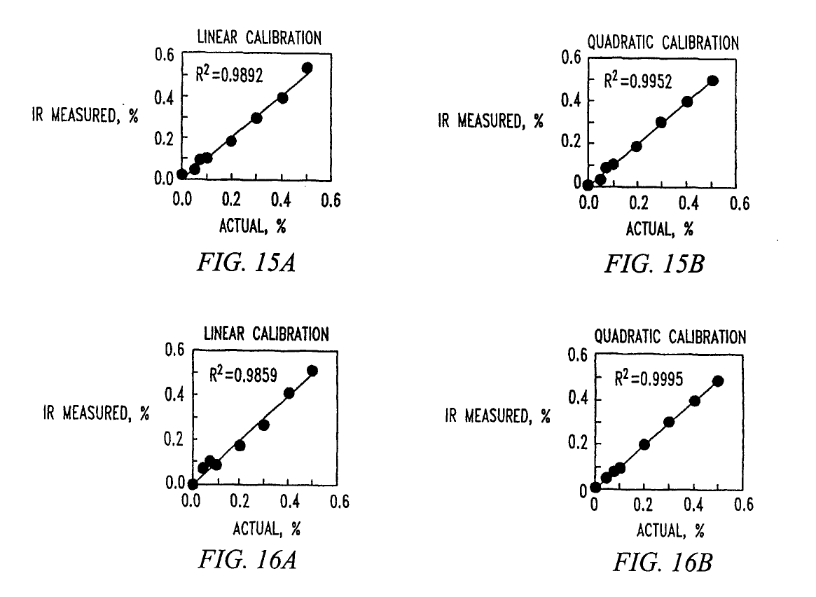

FIGS. 15A and 15B show the results of a one wavelength band and one reference wavelength band IMLR with linear and quadratic fits respectively. The correlations are down to 0.98 for the linear fit due to the presence of the lactate interferences. However, this is improved to 0.99 for the quadratic fit as the interaction effects are being accounted for.

FIGS. 16A and 16B show the results of a two wavelength band and a one reference wavelength band IMLR with linear and quadratic fits respectively. Correlations are down to 0.98 for the linear fit but a quadratic fit is seen to improve the correlation coefficient dramatically giving a correlation coefficient of 0.999.

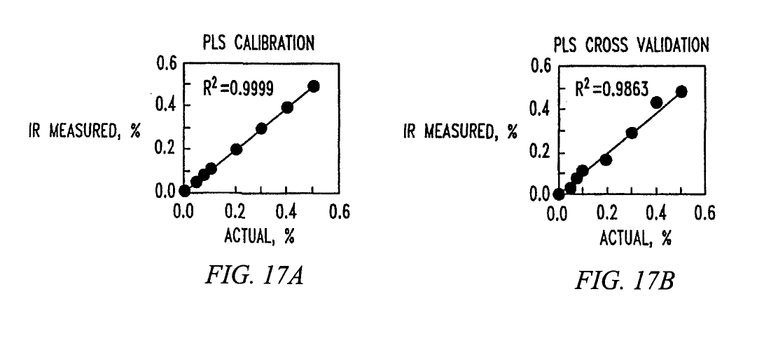

FIGS. 17A and 17B show the results of the multivariate (PLS) calibration in the about 1190 cm⁻¹ to about 980 cm⁻¹ (8.4-10.2 μm) range for LRS spiked with glucose. This region selection is broad and a multivariate method is able to correlate the glucose concentration to the spectral information in the presence of interfering spectra. FIG. 17A shows a high correlation coefficient of 0.9999 for the calibration. FIG. 17B shows the results of leave-1-out cross validation, the correlation coefficient being 0.9863. These results are close to those obtained for the IMLR with a quadratic fit indicating that there is not much loss of information in selecting a narrower range of wavelengths.

CFC Fluid

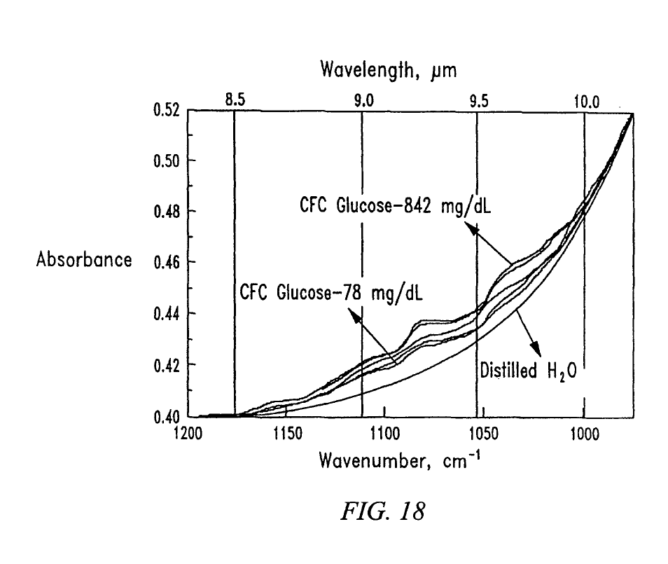

The spectra of CFC fluid samples in the spectral range of about 1200 25 cm⁻¹ to about 975 cm⁻¹ (8.3-10.3 μm) is shown in FIG. 18. These spectra further emphasize the need to select wavelength bands that have absorbance bands that correlate well with glucose absorbance so that the integrated absorbance calculation is able to obtain a reasonable fit. The shifts in baseline and the absorbance bands due to the presence of other chemicals are evident.

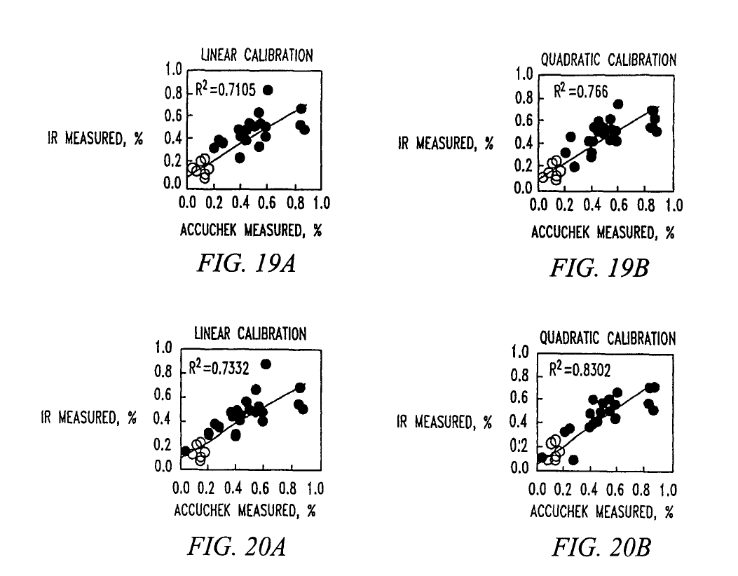

Again, the quadratic calibration model for the CFC fluid gave the best performance. It is seen that there is considerable deterioration of the calibration fit with linear models. It is noted here that the calibration wavelength bands needed to be selected differently as compared to the case of aqueous and LRS solutions. FIGS. 19A and 19B show the results of a one wavelength band and one reference wavelength band IMLR with linear and quadratic fits respectively. The darkened symbols represent CFC fluid collected from the diabetic rat and the non-darkened symbols represent CFC fluid collected prior to the rat becoming diabetic. The correlations are down to about 0.71 for the linear fit due to the presence of multiple interferences and possible complex interaction effects. A quadratic fit improves the correlation to 0.76 in FIG. 19B. FIGS. 20A and 20B show the results of a two wavelength band one reference wavelength band IMLR calibration with a linear and quadratic fit, respectively. The correlation with the linear calibration is about 0.73. An improvement in the correlation is obtained by inclusion of a third wavelength giving a correlation coefficient of 0.83 with the quadratic.

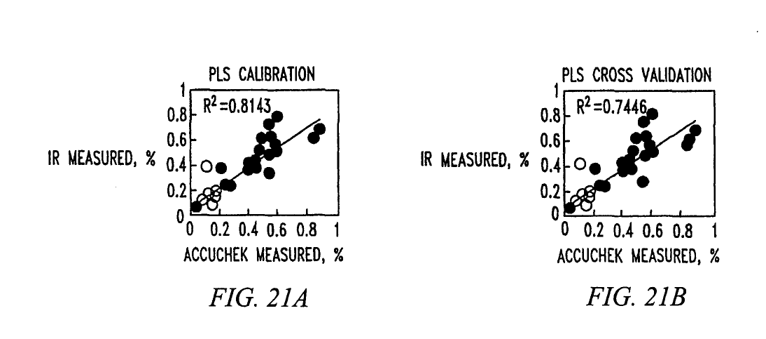

FIGS. 21A and 21B show the results of the multivariate (PLS) calibration in the about 1190 cm⁻¹ to about 980 cm⁻¹ (8.4-10.2 μm) range for glucose in CFC fluid. FIG. 21A shows a correlation coefficient of 0.814 for the calibration. However, FIG. 21B shows the results of leave-1-out cross validation, the correlation coefficient being down to 0.74 indicating the stability of the calibration. The pure component spectra extracted from the above measurements show excellent agreement with the absorption peaks in the pure glucose spectrum further validating the correlation with the glucose concentration. Finally, it is noted that the correlation coefficient for the multivariate analysis is close to that obtained for the quadratic fit IMLR. This indicates that most of the information that correlates with the glucose concentration is captured by the quadratic fit IMLR.

Human Serum Samples

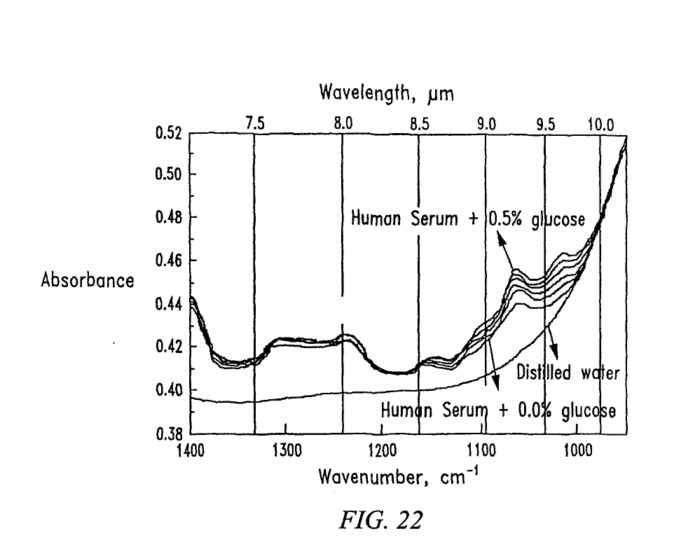

The spectra of glucose spiked human serum samples in the spectral range of about 1400 cm⁻¹ to about 975 cm⁻¹ (7.1-10.3 μm) are shown in FIG. 22. In particular, human serum samples (#P3 1876) were obtained from Fisher Scientific and restored to liquid by the addition of distilled water. The resulting serum was spiked with varied but known quantities of glucose and centrifuged for mixing.

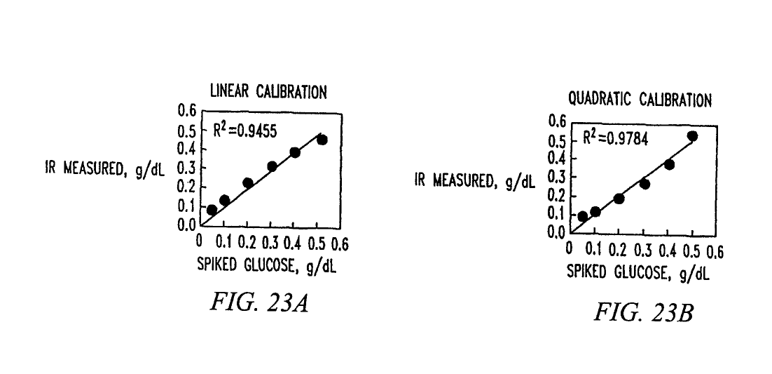

FIGS. 23A and 23B show the results of a one-wavelength band and one reference wavelength band IMLR with linear and quadratic fits, respectively. The wavelength bands chosen for this case were about 1195 cm⁻¹ to about 1185 cm⁻¹ (8.37-8.44 μm) for the reference wavelength band and about 1090 cm⁻¹ to about 1065 cm⁻¹ (9.17-9.39 μm) for the glucose wavelength band. The quadratic calibration shows a better fit as shown in FIG. 23B.

While the invention has been illustrated and described in detail in the drawings and foregoing description, such illustration and description is to be considered as exemplary and not restrictive in character, it being understood that only the preferred embodiments have been shown and described and that all changes and modifications that come within the spirit of the invention are desired to be protected.

1. A method of measuring an amount of an organic substance contained within a biological sample, said organic substance having an infrared absorption spectrum which includes a set (n) of wavelength regions, wherein each of said wavelength regions substantially correspond to an absorption band of said absorption spectrum, comprising:
(a) detecting the intensity of a number of selected wavelength bands of infrared electromagnetic radiation influenced by said organic substance contained within said biological sample with a detection system, wherein (i) each of said selected wavelength bands substantially corresponds to one of said wavelength regions and (ii) said number of said selected wavelength bands is equal to n−1 or less;
(b) generating an electrical signal in response to detecting the intensity of said number of said selected wavelength bands;
(c) receiving said electrical signal with a signal processor configured to process said electrical signal with a quantification algorithm; and processing said electrical signal with said quantification
(d) algorithm so as to provide a measurement of said amount of said organic substance contained with said biological sample.

2. The method of claim 1, including detecting the intensity of said selected wavelength bands of infrared electromagnetic radiation influenced by glucose with said detection system.

3. The method of claim 1, including collecting said biological sample from a mammal.

4. The method of claim 1, wherein:
said quantification algorithm of (c) includes dividing a first wavelength band integrated absorbance value by a reference wavelength band integrated absorbance value.

5. The method of claim 4, wherein:
said quantification algorithm of (c) further includes dividing a second wavelength band integrated absorbance value by said reference wavelength band integrated absorbance value.

6. The method of claim 1, wherein:
(a) includes detecting the intensity of (i) about 1090 cm−1 to about 1075 cm−1 wavelength band of infrared electromagnetic radiation and (ii) about a 1095 cm−1 to about 1090 cm⁻¹ wavelength band of infrared electromagnetic radiation.

7. The method of claim 1, wherein:
(a) includes detecting the intensity of (i) about a 1090 cm⁻¹ to about 1075 cm⁻¹ wavelength band of infrared electromagnetic radiation, (ii) about a 1175 cm⁻¹ to about 1137 cm⁻¹ wavelength band of infrared electromagnetic radiation, and (iii) about a 1180 cm⁻¹ to about 1170 cm⁻¹ wavelength band of infrared electromagnetic radiation.

8. The method of claim 1, wherein:
said number of selected wavelength bands of (a) are within a range The method of claim 1, wherein: defined by about 1400 cm⁻¹ to about 950 cm⁻¹.

9. A method of measuring an amount of glucose in a biological fluid, wherein said glucose has an infrared absorption spectrum which includes a set (n) of infrared wavelength regions, wherein each of said infrared wavelength regions substantially correspond to an infrared absorption band of said infrared absorption spectrum, comprising:
(a) detecting the transmittance of a number of selected wavelength bands of infrared electromagnetic radiation absorbed by said glucose contained within said biological fluid with a detection system, wherein (i) each of said selected wavelength bands substantially corresponds to one of said wavelength regions and (ii) said number of said selected wavelength bands is equal to n−1 or less;
(b) generating an electrical signal in response to detecting the transmittance of said infrared electromagnetic radiation;
(c) receiving said electrical signal with a signal processor configured to process said electrical signal with a quantification algorithm; and
(d) processing said electrical signal with said quantification algorithm so as to provide a measurement of said amount of said glucose contained within said biological fluid.

10. The method of claim 9, further comprising:
(e) collecting said biological fluid with a filtrate collector in fluid communication with a body fluid of a mammal.

11. The method of claim 10, wherein:
said mammal is a human.

12. The method of claim 9, wherein:
said quantification algorithm of (c) includes dividing a first wavelength band integrated absorbance value by a reference wavelength band integrated absorbance value.

13. The method of claim 9, wherein:
said quantification algorithm of (c) further includes dividing a second wavelength band integrated absorbance value by said reference wavelength band integrated absorbance value.

14. The method of claim 12, wherein:
(a) includes detecting the transmittance of (i) about a 1090 cm⁻¹ to about 1075 cm⁻¹ wavelength band of infrared electromagnetic radiation and (ii) about a 1095 cm⁻¹ to about 1090 cm⁻¹ wavelength band of infrared electromagnetic radiation.

15. The method of claim 13, wherein:
(a) includes detecting the transmittance of (i) about a 1090 cm⁻¹ to about 1075 cm⁻¹ wavelength band of infrared electromagnetic radiation, (ii) about a 1175 cm⁻¹ to about 1137 cm⁻¹ wavelength band of infrared electromagnetic radiation, and (iii) about a 1180 cm⁻¹ to about 1170 cm⁻¹ wavelength band of infrared electromagnetic radiation.

16. The method of claim 9, wherein:
said number of selected infrared wavelength bands of (a) are within a range defined by about 1400 cm⁻¹ to about 950 cm⁻¹.

17. A method of measuring a concentration of an organic substance contained within a biological fluid, said organic substance having an infrared absorption spectrum which includes a set (n) of infrared wavelength regions, wherein each of said infrared wavelength regions substantially correspond to an infrared absorption band of said infrared absorption spectrum, comprising:
(a) detecting the transmittance of a number of selected wavelength bands of infrared electromagnetic radiation absorbed by said organic substance contained within said biological fluid with a detection system, wherein (i) each of said selected wavelength bands substantially corresponds to one of said wavelength regions and (ii) said number of said selected wavelength bands is equal to n−1 or less;
(b) generating an electrical signal in response to detecting the transmittance of said selected infrared electromagnetic radiation wavelength bands;
(c) receiving said electrical signal with a signal processor configured to process said electrical signal with a mathematical model; and
(d) processing said electrical signal with said mathematical model so as to provide a measurement of the concentration of said organic substance contained within said biological fluid.

18. The method of claim 17, wherein:
(a) includes detecting the transmittance of said selected electromagnetic radiation wavelength bands absorbed by glucose contained within said biological fluid with said detection system.

19. The method of claim 18, wherein:
said mathematical model includes the mathematical equation
C_{g}=Pₒ+P₁IAR_{λ,1}+P₂IAR²_{λ,1}
wherein (i) C_{g} is the mean-centered concentration of glucose in said biological fluid, (ii) Pᵢ is a calibration constant, and (iii) IAR1_{λ,1} is a mean-centered integrated absorbance ratio of two of said selected wavelength bands.

20. The method of claim 18, wherein:
said mathematical model includes the mathematical equation
C_{g}=Pₒ+P₁IA²_{λ,1}+P₂IA²_{λ,1}+P₃IA²_{λ,1}+P₄IA²_{λ,2}+P₅IA_{λ,1}
wherein (i) C_{g} is the mean centered concentration of glucose in said biological fluid, (ii) Pᵢ are calibration constants, and (iii) IA_{λ,1} and IA_{λ,1} are the mean centered integrated absorbance for the selected wavelength band and the selected reference wavelength band.

21. The method of claim 18, wherein:
said mathematical model includes the mathematical equation
C_{g}=P₀+P₁IA_{λ,1}+P₂IAR_{λ,2}+P₃IAR²_{λ,1}+P₄IAR²_{λ,2}+P₅IAR_{λ,1}IAR_{λ,2}
wherein (i) C_{g} is the mean-centered concentration of glucose in said biological fluid, (ii) Pᵢ are calibration constants, and (iii) IAR_{λ,j} is a mean-centered integrated absorbance ratio of two of said selected wavelength bands.

22. The method of claim 18, wherein:
said mathematical model includes the mathematical equation
C_{g}=P₀+P₁IA_{λ,1},+P₂IA_{λ,2}+P₃IA_{λ,3}+P₄IA²_{λ,1}+P₅IA²_{λ,2}+P₆IA²_{λ,3}+P₇IA²_{λ,2}+P_{g}IA_{λ,3}+P₉IA_{λ,2}IA_{λ,3}
wherein (i) C_{g} is the mean centered concentration of glucose in said biological fluid, (ii) Pᵢ are calibration constants, and (iii) IA_{λ,j} is the mean centered integrated absorbance for band j.

23. A method of measuring an amount of an organic substance contained within a biological sample, said organic substance having an infrared absorption spectrum which includes a set (n) of wavelength regions, wherein each of said wavelength regions substantially correspond to an absorption band of said absorption spectrum, comprising:
(a) illuminating said biological sample with infrared electromagnetic radiation, wherein said infrared electromagnetic radiation includes (i) one or more wavelength bands of said infrared electromagnetic radiation which are absorbed by said organic substance contained within said biological sample (ii) one or more reference wavelength bands which are not substantially absorbed by said organic substance contained within said biological sample;
(b) selecting a number said wavelength bands of said infrared electromagnetic radiation, wherein (i) each of said selected wavelength bands substantially corresponds to one of said wavelength regions and (ii) said number of said selected wavelength bands is a subset of (n);
(c) selecting a number of reference wavelength bands;
(d) detecting the intensity of only (i) said subset of said selected wavelength bands absorbed by said organic substance contained within said biological sample with a detection system and (ii) said number of reference wavelength bands;
(e) generating one or more electrical signals in response to detecting the intensity of only (i) said subset of said selected wavelength bands (ii) said number of reference wavelength bands;
(f) receiving said one or more electrical signals with a signal processor configured to process said electrical signals with a quantification algorithm; and
(g) processing said one or more electrical signals with said quantification algorithm so as to provide a measurement of said amount of said organic substance contained within said biological sample.

24. A method of measuring an amount of an organic substance contained within a biological sample, said organic substance having an infrared absorption spectrum which includes a set (n) of wavelength regions, wherein each of said wavelength regions substantially correspond to an absorption band of said absorption spectrum, comprising:
(a) illuminating said biological sample with infrared electromagnetic radiation;
(b) detecting the intensity of said infrared electromagnetic radiation that is absorbed by said organic substance contained within said biological sample, wherein (i) said intensity detection is restricted to a number of selected wavelength bands of infrared electromagnetic radiation, (ii) each of said selected wavelength bands substantially corresponds to one of said wavelength regions, and (iii) said number of said selected wavelength bands is a subset of (n);
(c) generating an electrical signal in response to detecting the intensity of said subset of said selected wavelength bands;
(d) receiving said electrical signal with a signal processor configured to process said electrical signal with a quantification algorithm; and
(e) processing said electrical signal with said quantification algorithm so as to provide a measurement of said amount of said organic substance contained within said biological sample.

25. The method of claim 22, further comprising:
(f) detecting the intensity of one or more reference wavelengths bands of said infrared electromagnetic radiation which are not absorbed by said organic substance contained within said biological sample,
wherein (c) includes generating said electrical signal in response to detecting the intensity of said one or more reference wavelength bands.

26. A method of measuring an amount of an organic substance contained within a sample, said organic substance having an infrared absorption spectrum which includes a set (n) of wavelength regions, wherein each of said wavelength regions substantially correspond to an absorption band of said absorption spectrum, comprising:
(a) illuminating said sample with infrared electromagnetic radiation, wherein said infrared electromagnetic radiation includes (i) one or more wavelength bands of said infrared electromagnetic radiation which are absorbed by said organic substance contained within said sample (ii) one or more reference wavelength bands which are substantially not absorbed by said organic substance contained within said sample;
(b) selecting a number said wavelength bands of said infrared electromagnetic radiation, wherein (i) each of said selected wavelength bands substantially corresponds to one of said wavelength regions and (ii) said number of said selected wavelength bands is a subset of (n);
(c) selecting a number of reference wavelength bands; and
(d) detecting with a detection system the intensity of only (i) said subset of said selected wavelength bands absorbed by said organic substance contained within said sample and (ii) said number of reference wavelength bands.

27. A method of measuring an amount of an organic substance contained within a biological sample, said organic substance having an infrared absorption spectrum which includes a set (n) of wavelength regions, wherein each of said wavelength regions substantially correspond to an absorption band of said absorption spectrum, comprising:
(a) illuminating said biological sample with infrared electromagnetic radiation, wherein said infrared electromagnetic radiation includes (i) one or more wavelength bands of said infrared electromagnetic radiation which are absorbed by said organic substance contained within said biological sample and (ii) one or more reference wavelength bands which are substantially not absorbed by said organic substance contained within said biological sample;
(b) selecting a number said wavelength bands of said infrared electromagnetic radiation, wherein (i) each of said selected wavelength bands substantially corresponds to one of said wavelength regions and (ii) said number of said selected wavelength bands is a subset of (n);
(c) selecting a number of reference wavelength bands;
(d) detecting with a detection system the intensity of said infrared electromagnetic radiation; and
(e) processing with a mathematical model spectral data only from (i) said subset of said selected wavelength bands absorbed by said organic substance contained within said biological sample and (ii) said number of reference wavelength bands.

28. A method for determining a patient glucose level, comprising:
(1) obtaining a sample of a cell-free, blood-based body fluid in a sample container having a pre-defined measurement path;
(2) passing an incident infrared signal through said sample over said measurement path, wherein (a) said incident signal comprises wavelengths in a measurement range of from 7 to 11 microns, (b) said incident signal comprises at least two glucose absorbance bands in said measurement range and at least one reference band, and (c) said incident signal is modulated;
(3) detecting a post-absorbance signal comprising all three of said bands after said incident signal is absorbed by said sample using a detector configured to preferentially detect said modulated signal relative to unmodulated signals; and
(4) calculating glucose concentration in said sample from said post-absorbance signal.

29. The method of claim 28, wherein said body fluid is plasma, serum, or interstitial fluid.

30. The method of claim 29, wherein said body fluid is interstitial fluid.

31. The method of claim 28, wherein said sample is transported from a source location at or inside a patient body to a measurement location outside a patient body and said measurement container is present at said measurement location.

32. The method of claim 30, wherein said source location is at an implanted needle site, a subcutaneous membrane surface, or a skin surface subjected to ionoporation, microporation, or reverse ionophoresis.

33. The method of claim 30, wherein said interstitial fluid is filtered to remove proteins prior to passing said infrared signal through said sample.

34. The method of claim 33, wherein at least 80% of said proteins are removed prior to passing said infrared signal through said sample.

35. The method of claim 34, wherein at least 96% of said proteins are removed prior to passing said infrared signal through said sample.

36. The method of claim 35, wherein at least 98% of said proteins are removed prior to passing said infrared signal through said sample.

37. The method of claim 29, wherein said body fluid has been passed through a filter having a molecular weigh cut off in a range from 10 kD to 100 kD prior to passing said infrared signal through said sample.

38. The method of claim 29, wherein said body fluid has been passed through a filter having a molecular weigh cut off in a range from 10 kD to 40 kD prior to passing said infrared signal through said sample.

39. The method of claim 29, wherein said body fluid has been passed through a filter having a molecular weight cut off in a range from 10 kD to 25 kD prior to passing said infrared signal through said sample.

40. The method of claim 28, wherein said measurement path has a length in a range from 5 to 60 microns.

41. The method of claim 40, wherein said measurement path has a length in a range from 15 to 35 microns.

42. The method of claim 28, wherein said two glucose absorbance bands are a first and a second glucose absorbance band selected so that said first glucose absorbance band has a first relative absorbance for an interfering substance potentially present in said body fluid and said second glucose absorbance band has a second relative absorbance for said interfering substance, wherein said first and second relative absorbances are different from each other.

43. The method of claim 42, wherein said incident signal further comprises a third glucose absorbance band selected so that said third glucose absorbance band has (a) a third relative absorbance for said interfering substance potentially present in said body or (b) a fourth relative absorbance for a second interfering substance potentially present in said body.

44. The method of claim 42, wherein said interfering substance is lactic acid, a lactate salt, ascorbic acid, an ascorbate salt, mannitol, acetaminophen, ethanol, or a phosphate salt.

45. The method of claim 43, wherein said interfering substance is lactic acid or a lactate salt and said second interfering substance is ascorbic acid, an ascorbate salt, mannitol, acetaminophen, ethanol, or a phosphate salt.

46. The method of claim 33, wherein said two glucose bands are selected to be within or to overlap ranges selected from 1090 cm⁻¹ to 1075 cm⁻¹ [9.174 to 9.302 microns], 1175 cm⁻¹ to 1137 cm⁻¹ [8.511 to 8.795 microns], and 1180 cm⁻¹ to 1170 cm⁻¹ [8.475 to 8.547 microns]

47. The method of claim 33, wherein said two glucose bands are selected to be within or to overlap ranges selected from a band having a center wavelength of 7.930 microns and a bandwidth of 170 nm [7.845 to 8.015 microns], a band having a center wavelength of 9.320 microns and a bandwidth of 400 nm [9.120 to 9.520 microns], and a band having a center wavelength of 8.330 microns and a bandwidth of 140 nm [8.260 to 8.400 microns].

48. The method of claim 30, wherein said two glucose bands are selected to be within or to overlap ranges selected from a band having a center wavelength of 9.62 microns and a bandwidth of 200 nm, a band having a center wavelength of 9.22 microns and a bandwidth of 200 nm, a band having a center wavelength of 8.62 microns and a bandwidth of 200 nm, a band having a center wavelength of 9.02 microns and a bandwidth of 200 nm, and a band having a center wavelength of 7.33 microns and a bandwidth of 200 nm.

49. The method of claim 28, wherein said fluid is interstitial fluid, wherein said interstitial fluid is transported from a source location at or inside a patient body to a measurement location outside a patient body and said measurement container is present at said measurement location, wherein said interstitial fluid is passed through a filter having a molecular weight cut off in a range from 10 kD to 40 kD prior to passing said infrared signal through said sample, wherein said measurement path has a length in a range from 20 to 30 microns, and wherein said post-absorbance signal contains glucose absorbance date from a region from 8.3 to 10.3 microns.

50. The method of claim 28, wherein said modulated signal is modulated by varying at least a part of the current, the voltage, or the frequency provided to the device that generates the incident infrared signal.

51. The method of claim 28 wherein said incident signal is modulated by the periodic insertion of an infrared blocking material.

52. The method of claim 50 further comprising performing a second modulation technique on the infrared signal.

53. The method of claim 51 further comprising performing a second modulation technique on the infrared signal.

54. The method of claim 50 wherein the modulated signal is the emitter output modulated at from 01 Hz to 10 Hz and the second modulation technique includes placing and removing a radiation absorbing material in the pathway of the infrared signal.

55. The method of claim 54 wherein the modulated signal is the emitter output modulated at 3 Hz.

56. The method of claim 28, wherein the sample cell window material is selected from the group consisting of: barium fluoride, silicon and zinc selenide.

57. A method for determining a patient glucose level, comprising:
(1) obtaining a sample of a biological fluid in a sample cell having a path of defined pathlength for infrared absorption;
(2) transmitting mid infrared radiation through said sample along said path, wherein (a) said incident signal comprises at least two glucose absorbance bands and at least one reference band, and (b) said transmitted radiation is modulated;
(3) detecting radiation from said two glucose absorbance bands and said reference band after said radiation is absorbed by said sample using a detector configured to detect said modulated radiation; and
(4) generating an electrical signal in response to detecting said modulated radiation;
(5) receiving said electrical signal with a signal processor configured to process the electrical signal with a quantification algorithm; and
(6) processing said electrical signal with said quantification algorithm, thereby providing a measurement of glucose contained within the biological sample.

58. The method of claim 57, wherein said mid infrared radiation comprises wavelengths in a range of from 1200 cm⁻¹ to 900 cm⁻¹.

59. The method of claim 57, wherein said biological fluid is plasma, serum, or capillary filtrate fluid.

60. The method of claim 59, wherein said biological fluid is capillary filtrate fluid.

61. The method of claim 60, wherein said sample of capillary filtrate fluid is transported from a subcutaneous location to said sample cell.

62. The method of claim 59, wherein said capillary filtrate fluid is filtered prior to passing said infrared signal through said sample.

63. The method of claim 62, wherein said capillary filtrate fluid is passed through an ultrafiltration membrane at a subcutaneous location of said patient.

64. The method of claim 63, wherein said ultrafiltration membrane passes organics having less than 3000 molecular weight.

65. The method of claim 64, wherein said membrane has a molecular weigh cut off of 30.

66. The method of claim 57, wherein said two glucose absorbance bands are selected so that a first glucose absorbance band has a first absorbance ratio for an interfering substance potentially present in said biological fluid and said second glucose absorbance band has a second absorbance ratio for said interfering substance.

67. The method of claim 66, wherein said transmitted mid infrared radiation further comprises a third glucose absorbance band.

68. The method of claim 66, wherein said interfering substance is lactate.

69. The method of claim 57, wherein said biological fluid is capillary filtrate fluid, said capillary filtrate fluid is transported from a subcutaneous location to said sample cell, said capillary filtrate fluid is passed through an ultrafiltration membrane that allows passage of organics of less than 3000 molecular weight and wherein said detected radiation contains glucose absorbance bands in a region from 1200 cm⁻¹ to 950 cm⁻¹.

70. An apparatus for measuring a patient glucose level, comprising:
(1) an ultrafiltration membrane adapted to be placed at a subcutaneous location in a patient body, wherein said membrane allows passage of capillary filtrate fluid;
(2) a catheter operably connected to said membrane to transport a capillary filtrate fluid from said subcutaneous location to a location outside said patient body;
(3) a vacuum operably connected to said catheter and providing motive force to fluid in said catheter;
(4) a sample cell having a defined path for passage of infrared radiation through a sample of capillary fluid filtrate, wherein said sample cell is operably connected to said catheter for receiving capillary filtrate from said subcutaneous location;
(5) a mid infrared radiation source adapted to transmit over said defined path, wherein (a) said radiation comprises at least two glucose absorbance bands and at least one reference band, and (b) said transmitted radiation is modulated;
(6) a detector for detecting radiation from said two glucose absorbance bands and said reference band after said radiation is absorbed by said sample, wherein said detector generates an electrical signal in response to detecting said modulated radiation; and
(7) a signal processor configured to process said electrical signal with a quantification algorithm, thereby providing a measurement of glucose contained within capillary filtrate fluid.

71. The apparatus of claim 70, further comprising a power supply operably connected to said infrared radiations source, said detector, and said signal processor.

72. The apparatus of claim 70, wherein said membrane has a molecular weight cut off of 30 kD.

73. The apparatus of claim 70, wherein said membrane passes drugs and organics of less than 3000 molecular weight.

74. An apparatus for detecting information to be used in determining a patient glucose level in a fluid, comprising:
(1) a measurement container for receiving fluid at a measurement location, said measurement container being adapted to allow an infrared signal to pass through said fluid over a measurement path of predetermined length;
(2) a signal generator adapted to transmit an incident signal over said measurement path, wherein (a) said incident signal comprises wavelengths in a measurement range of from 7 to 11 microns, (b) said incident signal comprises at least two glucose absorbance bands in said measurement range and at least one reference band, and (c) said incident signal is modulated; and
(3) a detector located to detect a post-absorbance signal comprising all three of said bands after said incident signal is absorbed by said sample, wherein said detector is configured to preferentially detect said modulated signal relative to unmodulated signals.

75. The apparatus of claim 74, further comprising:
(1) a conduit adapted to channel a cell-free, blood-based body fluid from a source location at or in a patient body to said measurement location, wherein said measurement location is outside a patient body;
(2) optionally, a first filter operably connected to said conduit between said source location and said measurement location, wherein said first filter removes cells from a blood-based body fluid obtained at said source location if cells are present in said body fluid; and
(3) a pump operably connected to said conduit and providing motive force to fluid in said conduit.

76. The apparatus of claim 74, further comprising a calculator, wherein said post-absorbance signal is transmitted to said calculator and said calculator determines glucose concentration data in said fluid from said post-absorbance signal, (a) transmits said data to a display or (b) transmits said data to a controller of an insulin infusion pump, or (c) stores said data for later retrieval.

77. The apparatus of claim 74, further comprising a waste collection site for collecting said body fluid after said fluid has passed through said measurement container, thereby allowing a further patient glucose level to be determined at a later time.

78. The apparatus of claim 75, further comprising an energy source capable of powering said pump, said signal generator, and said detector.

79. The apparatus of claim 75, further comprising an electrical connection for connecting said pump, said signal generator, said detector, or a combination thereof to an external power source.

80. The apparatus of claim 74, further comprising an insulin infusion pump operably integrated into said apparatus, wherein said infusion pump injects insulin into said patient under control of electronic circuitry that receives post-absorbance-signal information from said detector.

81. The apparatus of claim 75, wherein said conduit comprises a tube operably connected at one end to said measurement container and operably connected at its other end to a needle, a detachable needle connector, or a skin patch.

82. The apparatus of claim 75, wherein said pump comprises a vacuum pump or other suction pump operably connected to said conduit and located distally to said measurement container, whereby said pump pulls said fluid into said container from said source location.

83. The apparatus of claim 75, wherein either said first filter or a second filter operably connected to said conduit prior to said detection location has a molecular weight cut off in a range from 10 kD to 40 kD.

84. The apparatus of claim 74 wherein the measurement container is a sample cell having a pair of windows.

85. The apparatus of claim 84 wherein the windows have a surface roughness of less than 1 micron.

86. The apparatus of claim 84 wherein the windows are fabricated from a material selected from the group consisting of: barium fluoride, silicon and zinc selenide.

87. The apparatus of claim 84 wherein the windows define a cell path ratio between 0.2 and 0.01.

88. The apparatus of claim 87 wherein the cell path ratio is 0.04.
